(19) United States
(12) Patent Application Publication
(10) Pub. No.: US 2013/0222738 A1
(43) Pub. Date: Aug. 29, 2013

(54) COLOR LIQUID CRYSTAL DISPLAY DEVICE

(71) Applicants: Bar-Yuan Hsieh, Taichung City (TW); Jung-Pin Hsu, Tainan City (TW); Bo-Hsuan Lin, Tainan City (TW)

(72) Inventors: Bar-Yuan Hsieh, Taichung City (TW); Jung-Pin Hsu, Tainan City (TW); Bo-Hsuan Lin, Tainan City (TW)

(73) Assignee: CHI MEI CORPORATION, Tainan City (TW)

(21) Appl. No.: 13/762,571

(22) Filed: Feb. 8, 2013

(30) Foreign Application Priority Data
Feb. 24, 2012 (TW) 101106334

(51) Int. Cl. G02F 1/1335

(52) U.S. Cl. CPC G02F 1/133514
USPC 349/69; 349/106; 349/70

(57) ABSTRACT

A color liquid crystal display device having high color reproduction is provided, which includes a liquid crystal display element and a backlight unit. The liquid crystal display element includes a color filter having a blue filter segment, a green filter segment, and a red filter segment. The blue filter segment is prepared from a blue photosensitive resin composition which includes a blue pigment combination, a red dye component, an alkali-soluble resin, a compound having at least one ethylenically unsaturated group, a photoinitiator, and a solvent. The blue pigment combination includes a copper phthalocyanine-based blue pigment. The backlight unit is coupled to the liquid crystal display element and has a color temperature ranging from 8,000 K to 20,000 K.

### CROSS-REFERENCE TO RELATED APPLICATION

This application claims priority of Taiwanese Application No. 101106334, filed on Feb. 24, 2012.

### BACKGROUND OF THE INVENTION

1. Field of the Invention

This invention relates to a color liquid crystal display device, more particularly to a color liquid crystal display device capable of high color reproduction.

2. Description of the Related Art

Along with advancing technology and broadening applications, large-sized liquid crystal display devices with high color reproduction, such as liquid crystal display televisions, are being actively developed. Generally, NTSC color reproduction of desktop liquid crystal display devices ranges roughly from 50 percent to 60 percent while NTSC color reproduction of the liquid crystal television ranges roughly from 60 percent to 75 percent. Therefore, mere application of the components for the desktop liquid crystal display device, such as a liquid crystal display element and a backlight unit (for example, cold cathode fluorescent lamp (CCFL)), to the liquid crystal display television is not able to satisfy the color reproduction requirement for the liquid crystal display television.

When the backlight unit of the desktop liquid crystal display is used for the liquid crystal display television, a color filter must have a thicker blue filter segment or a denser blue pigment to satisfy the requirement of the color reproduction for the liquid crystal display television, which, however, may lead to drastic decrease in light permeability of the blue color filter segment.

JP-H09-095638 discloses a blue photosensitive resin composition for forming a color filter which is composed of an alpha-copper phthalocyanine blue pigment, an epsilon-copper phthalocyanine blue pigment, a photosensitive resin, a photoinitiator, and a solvent. Furthermore, JP-H09-197663 also discloses a blue photosensitive resin composition for forming a color filter which is composed of a copper phthalocyanine blue pigment, an indanthrone blue pigment, a photosensitive resin, a photoinitiator, and a solvent. These two blue photosensitive resin compositions can solve the abovementioned light permeability issues.

However, the application of the color filters formed with the blue photosensitive resin compositions coupled with the backlight unit of the desktop liquid crystal display devices to the liquid crystal display televisions is still not able to reach satisfactory brightness and color reproduction requirements of the liquid crystal display televisions. Therefore, one of the goals in the industry is to provide liquid crystal display televisions with high color reproduction so as to satisfy the current requirement.

### SUMMARY OF THE INVENTION

An object of the present invention is to provide a color liquid crystal display device having high color reproduction.

The color liquid crystal display device according to this invention includes a liquid crystal display element and a backlight unit. The liquid crystal display element includes a color filter having a blue filter segment, a green filter segment, and a red filter segment. The blue filter segment is prepared from a blue photosensitive resin composition which includes a blue pigment component (A), a red dye component (B), an alkali-soluble resin (C), a compound having at least one ethylenically unsaturated group (D), a photoinitiator (E), and a solvent (F). The blue pigment component (A) includes a copper phthalocyanine-based blue pigment (A-1).

The backlight unit is coupled to the liquid crystal display element and has a color temperature ranging from 8,000 K to 20,000 K.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a preferred embodiment of a color liquid crystal display device according to this invention; and

FIG. 2 is a sectional view of a white light emitting diode used in the preferred embodiment.

### DETAILED DESCRIPTION OF THE PREFERRED EMBODIMENTS

### [Blue Photosensitive Resin Composition]

The blue photosensitive resin composition according to the present invention includes a blue pigment component (A), a red dye component (B), an alkali-soluble resin (C), a compound having at least one ethylenically unsaturated group (D), a photoinitiator (E), a solvent (F), and an optionally added functional additive (G).

The following is a detailed description of the components of the blue photosensitive resin composition.

### <Blue Pigment Component (A)>

The blue pigment component (A) includes a copper phthalocyanine-based blue pigment (A-1). The blue pigment component (A) is used in an amount ranging from 1 part by weight to 100 parts by weight, preferably from 3 parts by weight to 95 parts by weight, and more preferably from 5 parts by weight to 90 parts by weight based on 100 parts by weight of the alkali-soluble resin (C). The copper phthalocyanine-based blue pigment (A-1) is used in an amount ranging from 1 part by weight to 90 parts by weight, preferably from 3 parts by weight to 85 parts by weight, and more preferably from 5 parts by weight to 80 parts by weight based on 100 parts by weight of the alkali-soluble resin (C).

Examples of the copper phthalocyanine-based blue pigment (A-1) can be used alone or in admixture of two or more thereof, and include, but are not limited to, C.I. Pigment Blue 15:1, C.I. Pigment Blue 15:2, C.I. Pigment Blue 15:3, C.I. Pigment Blue 15:4, C.I. Pigment Blue 15:5, and C.I. Pigment Blue 15:6.

Preferably, the blue pigment component (A) further includes a violet pigment (A-2) which is beneficial in forming a color liquid crystal display device with better color reproduction. The violet pigment (A-2) is used in an amount ranging from 0 part by weight to 10 parts by weight, preferably from 0.3 part by weight to 5 parts by weight, and more preferably from 0.5 part by weight to 3 parts by weight based on 100 parts by weight of the alkali-soluble resin (C).

Examples of the violet pigment (A-2) can be used alone or in admixture of two or more thereof, and include, but are not limited to, C.I. Pigment Violet 14, C.I. Pigment Violet 19, C.I. Pigment Violet 23, C.I. Pigment Violet 29, C.I. Pigment Violet 32, C.I. Pigment Violet 33, C.I. Pigment Violet 36, C.I. Pigment Violet 37, C.I. Pigment Violet 38, C.I. Pigment Violet 40, and C.I. Pigment Violet 50.

The blue pigment component (A) may further include a halogenated-phthalocyanine-based green pigment so as to adjust chromaticity.

Preferably, the halogenated-phthalocyanine-based green pigment is selected from C.I. Pigment Green 07, C.I. Pigment Green 36, C.I. Pigment Green 37, C.I. Pigment Green 42, C.I. Pigment Green 58, and combinations thereof. More preferably, the halogenated-phthalocyanine-based green pigment is selected from C.I. Pigment Green 07, C.I. Pigment Green 36, C.I. Pigment Green 37, C.I. Pigment Green 42, C.I. Pigment Green 58, and combinations thereof.

### <Red Dye Component (B)>

The red dye component (B) is beneficial for improving brightness and adjusting chromaticity of the blue photosensitive resin composition. The color liquid crystal display device made without using the red dye component (B) has inferior color reproduction.

Preferably, the red dye component (B) includes a red dye having formula (I):

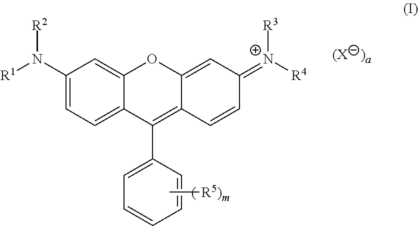

wherein

R¹, R², R³, and R⁴ are independently selected from the group consisting of hydrogen, —R⁶, and a C₆-C₁₀ aryl group unsubstituted or substituted with a substituent selected from the group consisting of halogen, —R⁶, —OH, —OR⁶, —SO₃H, —SO₃M, —COOH, —COOR⁶, —SO₃R⁶, —SO₂NHR⁸, and —SO₂NR⁸R⁹;

R⁵ is selected from the group consisting of —SO₃⁻, —SO₃H, —SO₃M, —COOH, —COOR⁶, —SO₃R⁶, —SO₂NHR⁸, and —SO₂NR⁸R⁹;

m is an integer ranging from 0 to 5, a plurality of R⁵s being the same or different when m is from 2 to 5;

X represents halogen;

a is 0 or 1;

R⁶ is a C₁-C₁₀ alkyl group unsubstituted or substituted with halogen, —CH₂— contained in the C₁-C₁₀ alkyl group being optionally replaced with —O—, carbonyl, or —NR⁶—;

R⁸ and R⁹ are independently selected from the group consisting of a C₁-C₁₀ straight chain alkyl group, a C₁-C₁₀ branched chain alkyl group, a C₃-C₃₀ cycloalkyl group, and -Q, and optionally join together to form a C₁-C₁₀ heterocyclic group unsubstituted or substituted with a substituent selected from the group consisting of R⁶, —OH, and -Q, the C₁-C₁₀ straight chain alkyl group, the C₁-C₁₀ branched chain alkyl group, and the C₃-C₃₀ cycloalkyl group being unsubstituted or substituted with a substituent selected from the group consisting of hydroxyl, halogen, -Q, —CH═CH₂, and —CH═CH—R⁶, —CH₂— contained in the C₁-C₁₀ straight chain alkyl group, the C₁-C₁₀ branched chain alkyl group, and the C₃-C₃₀ cycloalkyl group being optionally replaced with —O—, carbonyl, or —NR⁶—;

Q is selected from the group consisting of a C₆-C₁₀ aryl group and a C₅-C₁₀ heteroaryl group, which are independently unsubstituted or substituted with a substituent selected from the group consisting of halogen, —R⁶, —OH, —OR⁶, —NO₂, —CH═CH₂, and —CH═CH—R⁶; and

M is selected from the group consisting of potassium and sodium.

Examples of the R⁶ include, but are not limited to, methyl, ethyl, propyl, isopropyl, butyl, isobutyl, pentyl, isopentyl, neopentyl, cyclopentyl, hexyl, cyclohexyl, heptyl, cycloheptyl, octyl, cyclooctyl, 2-ethylhexyl, nonyl, decyl, tricycle(5.3.0.0^{3,10})decanyl, methoxypropyl, hexyloxypropyl, 2-ethylhexyloxypropyl, methoxyhexyl, and epoxypropyl.

Examples of the C₆-C₁₀ aryl group include, but are not limited to, phenyl and naphthyl.

Examples of —SO₃R⁶ include, but are not limited to, methanesulfonyl, ethanesulfonyl, hexanesulfonyl, and decanesulfonyl.

Examples of —COOR⁶ include, but are not limited to, methoxycarbonyl, ethoxycarbonyl, propoxycarbonyl, iso-propoxycarbonyl, butoxycarbonyl, iso-butoxycarbonyl, pentoxycarbonyl, iso-pentoxycarbonyl, neo-pentoxycarbonyl, cyclopentoxycarbonyl, hexoxycarbonyl, cyclohexoxycarbonyl, heptoxycarbonyl, cycloheptoxycarbonyl, octoxycarbonyl, cyclooctoxycarbonyl, 2-ethylhexoxycarbonyl, nonoxycarbonyl, decoxycarbonyl, tricycle(5.3.0.0^{3,10})decylcarbonyl, methoxypropoxycarbonyl, hexoxypropoxycarbonyl, 2-ethylhexoxypropoxycarbonyl, and methoxyhexoxycarbonyl.

Examples of —SO₂NHR⁸ include, but are not limited to, sulfamoyl, methylsulfamoyl, ethylsulfamoyl, propylsulfamoyl, iso-propylsulfamoyl, butylsulfamoyl, iso-butylsulfamoyl, pentylsulfamoyl, iso-pentylsulfamoyl, neo-pentylsulfamoyl, cyclopentylsulfamoyl, hexylsulfamoyl, cyclohexylsulfamoyl, heptylsulfamoyl, cycloheptylsulfamoyl, octylsulfamoyl, cyclooctylsulfamoyl, 2-ethylhexylsulfamoyl, nonylsulfamoyl, decylsulfamoyl, tricycle(5.3.0.0^{3,10})decylsulfamoyl, methoxypropylsulfamoyl, hexoxypropylsulfamoyl, 2-ethylhexoxypropylsulfamoyl, methoxyhexylsulfamoyl, epoxypropylsulfamoyl, 1,5-dimethylhexylsulfamoyl, propoxypropylsulfamoyl, iso-propoxypropylsulfamoyl, 3-phenyl-1-methylpropylsulfamoyl,

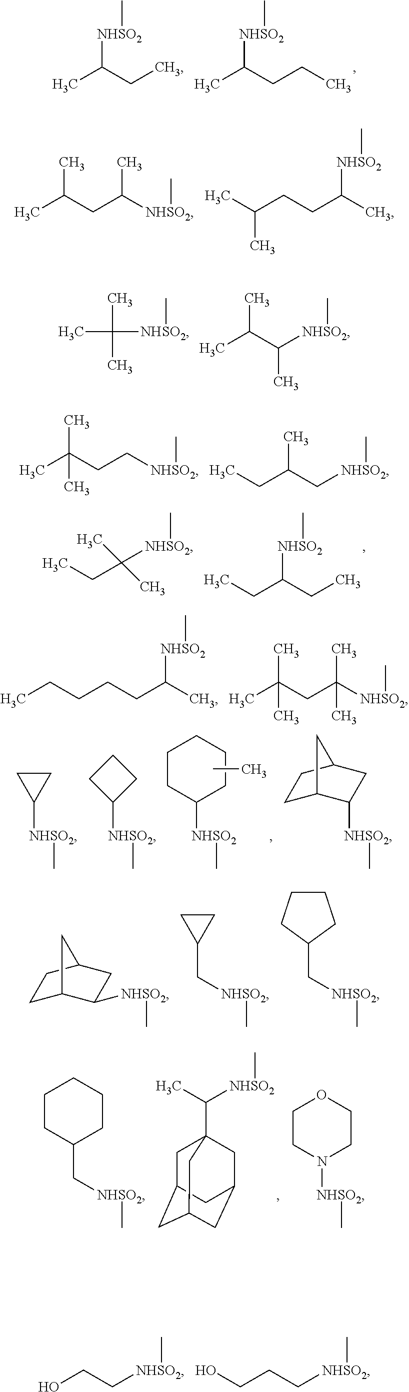

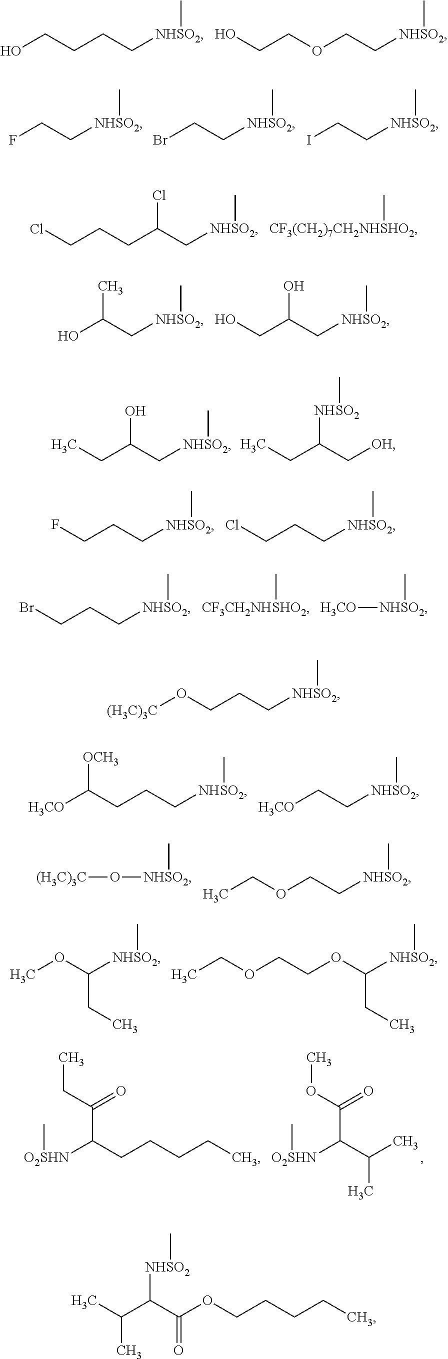

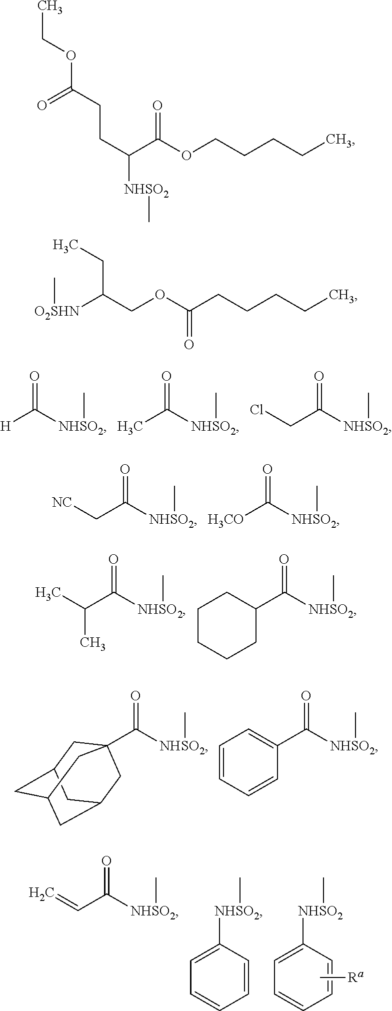

(wherein R^{a} denotes a C₁-C₃ alkyl group and a C₁-C₃ alkoxy, which are independently unsubstituted or substituted with halogen),

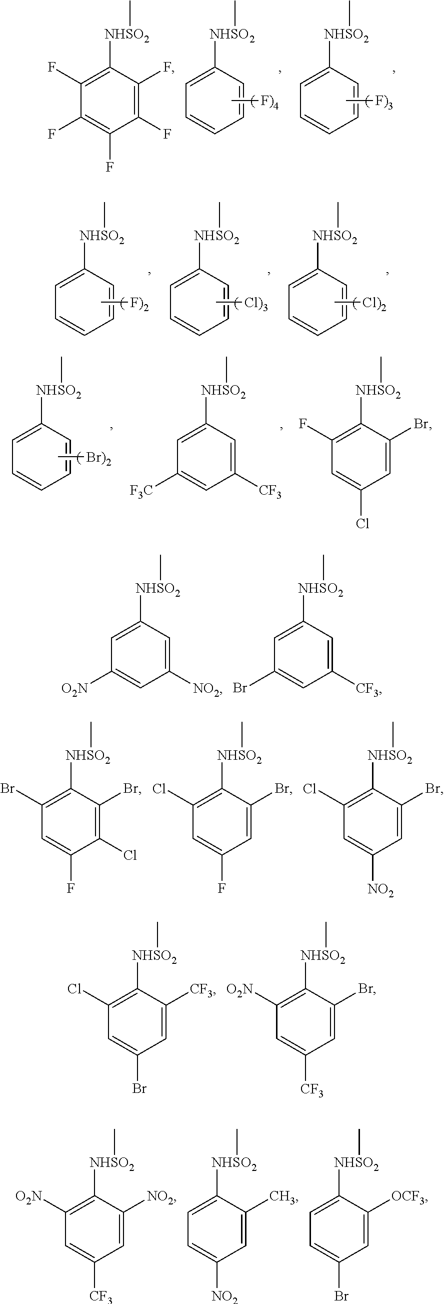

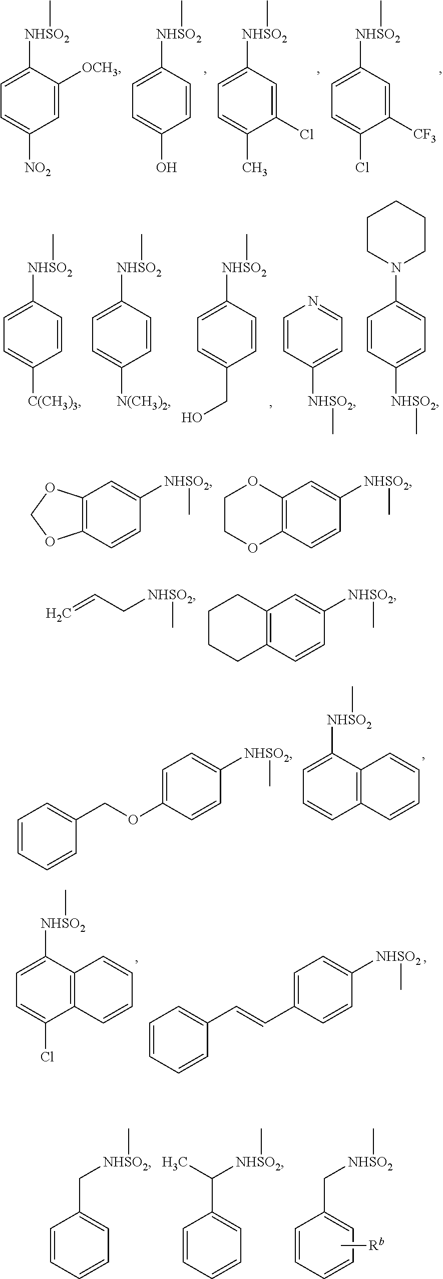

(wherein R^{b} denotes a C₁-C₃ alkyl group and a C₁-C₃ alkoxy, which are independently unsubstituted or substituted with halogen),

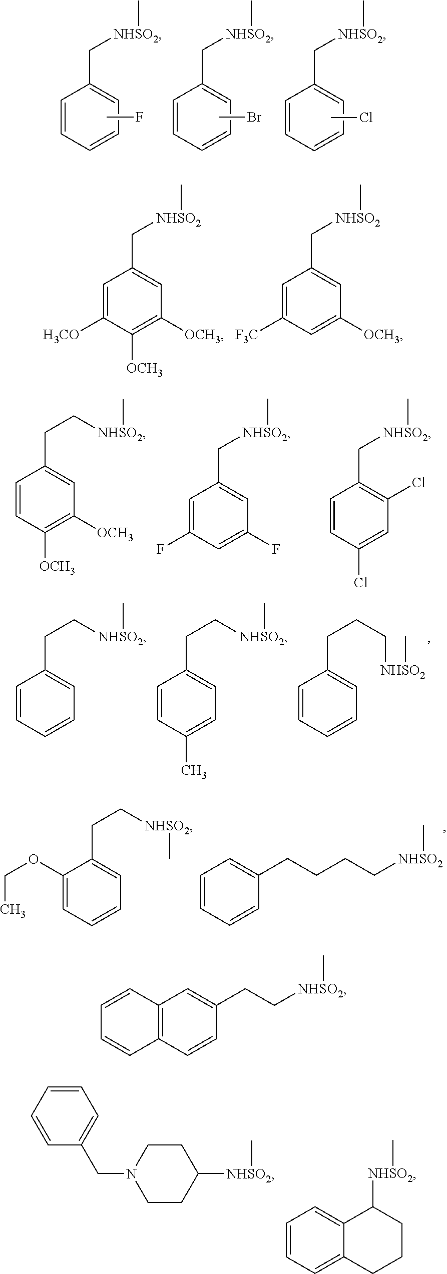

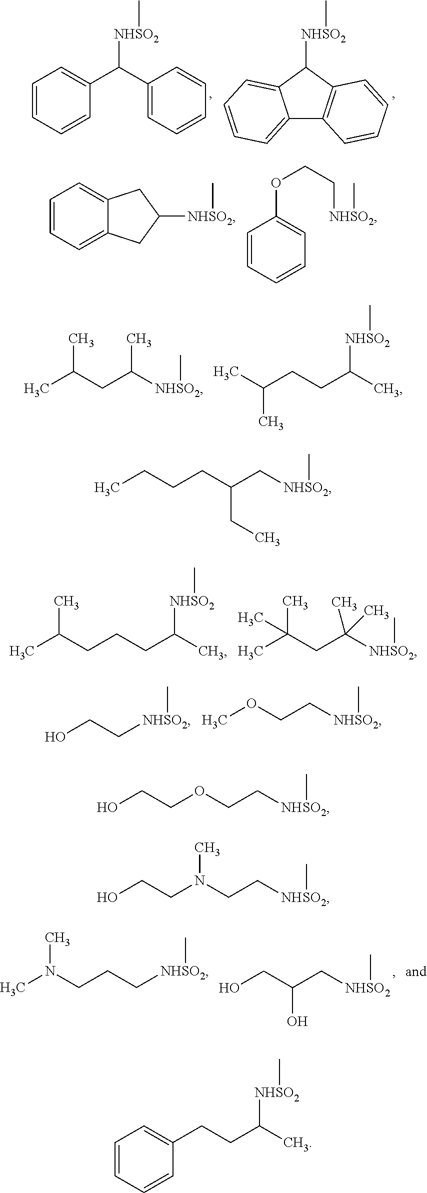

Examples of —SO₂NR⁸R⁹ include, but are not limited to,

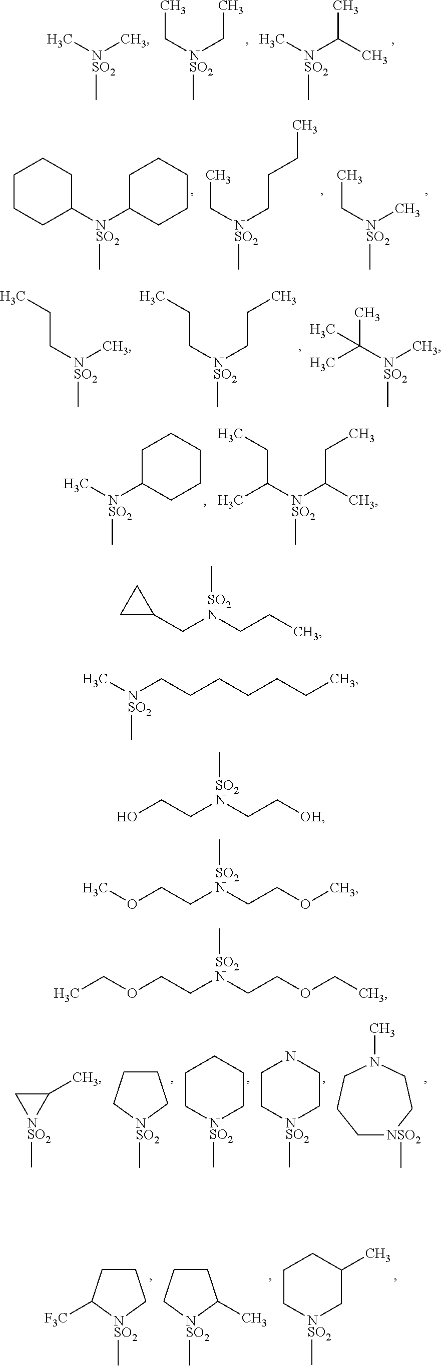

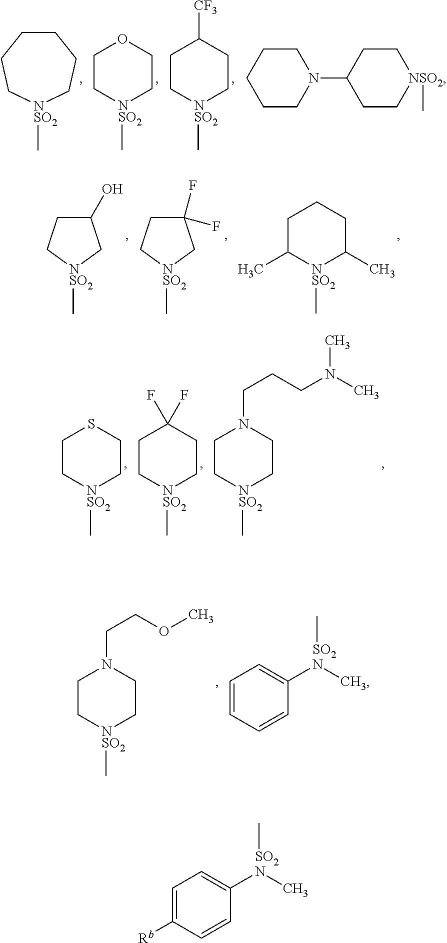

(wherein R^{b} denotes a C₁-C₃ alkyl group and a C₁-C₃ alkoxy which are independently unsubstituted or substituted with halogen),

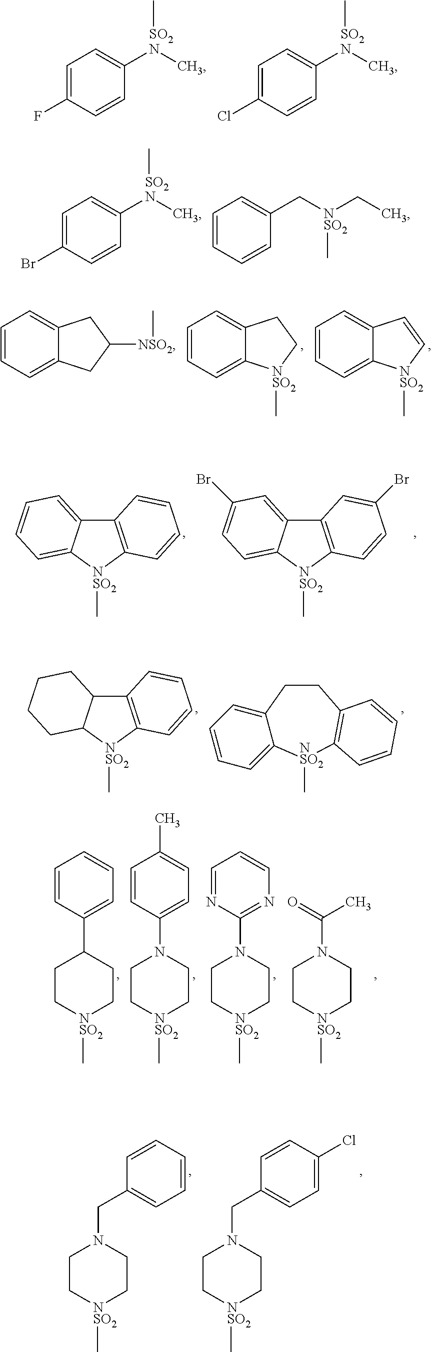

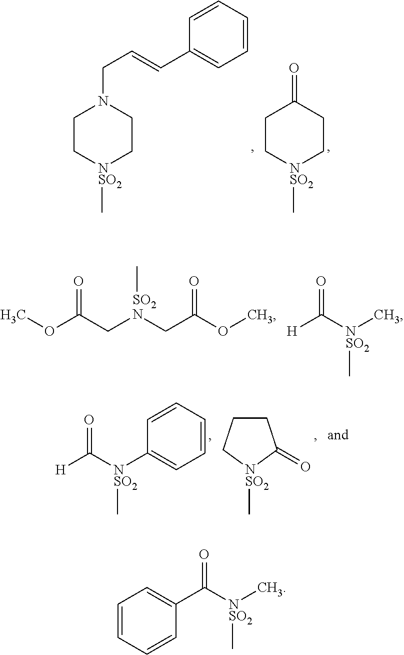

Preferably, the red dye component (B) includes a red pigment of formula (I-1):

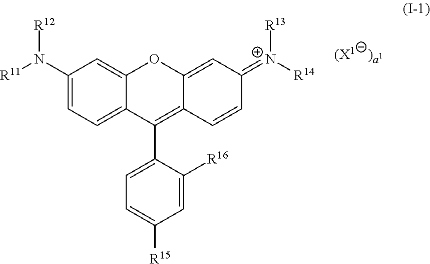

wherein

R¹¹, R¹², R¹³, and R¹⁴ are independently selected from the group consisting of hydrogen, —R⁶, and a C₆-C₁₀ aryl group unsubstituted or substituted with a substituent selected from the group consisting of halogen, —R⁶, —OH, —OR⁶, —SO₃⁻, —SO₃H, —SO₃Na, —COOH, —COOR⁶, —SO₃R⁶, —SO₂NHR⁸, and —SO₂NR⁸R⁹;

R¹⁵ is selected from the group consisting of hydrogen, —SO₃⁻, —SO₃H, —SO₂NHR⁸, and —SO₂NR⁸R⁹;

R¹⁶ is selected from the group consisting of —SO₃⁻, —SO₃H, —SO₂NHR⁸, and —SO₂NR⁸R⁹;

X¹ represents halogen;

a¹ is 0 or 1;

R⁶ is a C₁-C₁₀ alkyl group unsubstituted or substituted with halogen, —CH₂— contained in the C₁-C₁₀ alkyl group being optionally replaced with —O—, carbonyl, or —NR⁶—;

R⁸ and R⁹ are independently selected from the group consisting of a C₁-C₁₀ straight chain alkyl group, a C₁-C₁₀ branched chain alkyl group, a C₃-C₃₀ cycloalkyl group, and -Q, and optionally join together to form a C₁-C₁₀ heterocyclic group unsubstituted or substituted with a substituent selected from the group consisting of R⁶, —OH, and -Q, the C₁-C₁₀ straight chain alkyl group, the C₁-C₁₀ branched chain alkyl group, and the C₃-C₃₀ cycloalkyl group being unsubstituted or substituted with a substituent selected from the group consisting of hydroxyl, halogen, -Q, —CH═CH₂, and —CH═CH—R⁶, —CH₂— contained in the C₁-C₁₀ straight chain alkyl group, the C₁-C₁₀ branched chain alkyl group, and the C₃-C₃₀ cycloalkyl group being optionally replaced with —O—, carbonyl, or —NR⁶—; and

Q is selected from the group consisting of a C₆-C₁₀ aryl group and a C₅-C₁₀ heteroaryl group, which are independently unsubstituted or substituted with a substituent selected from the group consisting of halogen, —R⁶, —OH, —OR⁶, —NO₂, —CH═CH₂, and —CH═CH—R⁶.

Preferably, the red dye component (B) includes a red pigment of formula (I-2):

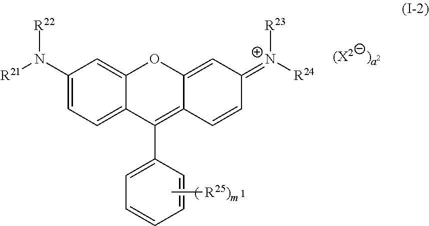

wherein

R²¹, R²², R²³, and R²⁴ are independently selected from the group consisting of hydrogen, —R²⁶, and a C₆-C₁₀ aryl group unsubstituted or substituted with a substituent selected from the group consisting of halogen, —R²⁶, —OH, —OR²⁶, —SO₃H, —SO₃Na, —COOH, —COOR²⁶, —SO₃R²⁶, and —SO₂NHR²⁸; R²⁵ is selected from the group consisting of —SO₃⁻, —SO₃Na, —COOH, —COOR²⁶, —SO₃H, and —SO₂NHR²⁸; m¹ is an integer ranging from 0 to 5, a plurality of R²⁵s being the same or different when m¹ is from 2 to 5;

X² represents halogen;

a² is 0 or 1;

R²⁶ is a C₁-C₁₀ alkyl group unsubstituted or substituted with a substituent selected from the group consisting of halogen and —OR²⁶; and

R²⁸ is selected from the group consisting of hydrogen, —R²⁶, —COOR²⁶, and a C₆-C₁₀ aryl group unsubstituted or substituted with a substituent selected from the group consisting of —R²⁶ and —OR²⁶.

Preferably, the red dye component (B) includes a red pigment of formula (I-3):

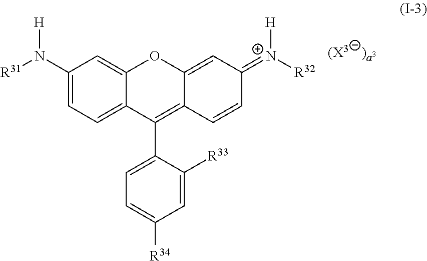

wherein

R³¹ and R³² are independently phenyl unsubstituted or substituted with a substituent selected from the group consisting of halogen, —R²⁶, —OR²⁶, —COOR²⁶, —SO₃R²⁶, and —SO₂NHR²⁸;

R³³ is selected from the group consisting of —SO₃⁻ and —SO₂NHR²⁸;

R³⁴ is selected from the group consisting of hydrogen, —SO₃⁻, and —SO₂NHR²⁸;

X³ is halogen;

a³ is 0 or 1;

R²⁶ is a C₁-C₁₀ alkyl group unsubstituted or substituted with a substituent selected from the group consisting of halogen and —OR²⁶; and

R²⁸ is selected from the group consisting of hydrogen, —R²⁶, —COOR²⁶, and a C₆-C₁₀ aryl group unsubstituted or substituted with a substituent selected from the group consisting of —R²⁶ and —OR²⁶.

Preferably, the red dye component (B) includes a red pigment of formula (I-4):

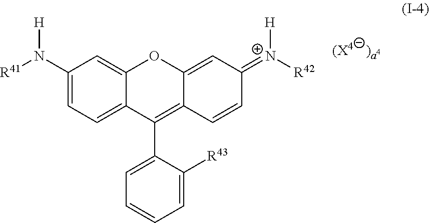

wherein

R⁴¹ and R⁴² are independently phenyl unsubstituted or substituted with a substituent selected from the group consisting of —R²⁶ and —SO₂NHR²⁸;

R⁴³ is selected from the group consisting of —SO₃⁻ and —SO₂NHR²⁸;

X⁴ is halogen;

a⁴ is 0 or 1;

R²⁶ is C₁-C₁₀ alkyl group unsubstituted or substituted with a substituent selected from the group consisting of halogen and —OR²⁶; and

R²⁸ is selected from the group consisting of hydrogen, —R²⁶, —COOR²⁶, and a C₆-C₁₀ aryl group unsubstituted or substituted with a substituent selected from the group consisting of —R²⁶ and —OR²⁶.

Examples of the red dye component (B) include, but are not limited to, the following:

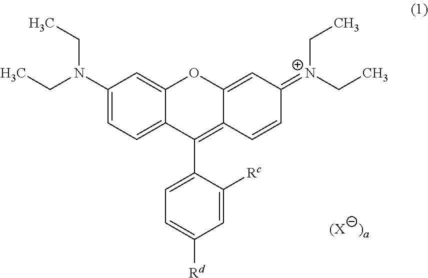

wherein

R^{c} and R^{d} are independently selected from the group consisting of hydrogen, —SO₃⁻, —COOH, and —SO₂NHR⁸;

R⁸ represents 2-ethylhexyl;

X represents halogen; and
a is 0 or 1,

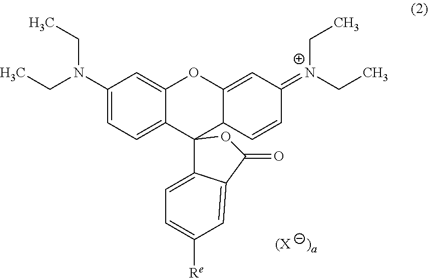

wherein

R^{e} is selected from the group consisting of hydrogen, —SO₃⁻, —COOH, and —SO₂NHR⁸;

R⁸ represents 2-ethylhexyl;

X represents halogen; and

a is 0 or 1,

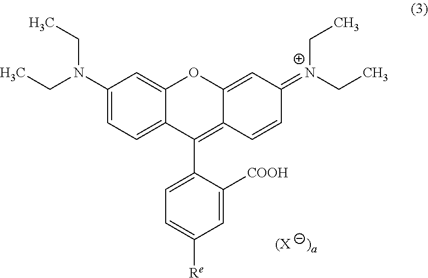

wherein

R^{e} is selected from the group consisting of hydrogen, —SO₃⁻, —COOH, and —SO₂NHR⁸;

R⁸ represents 2-ethylhexyl;

X represents halogen; and

a is 0 or 1,

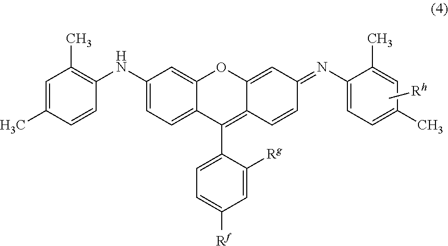

wherein

R^{f}, R^{g}, and R^{h} are independently selected from the group consisting of —SO₃⁻, —SO₃Na, and —SO₂NHR⁸; and

R⁸ represents 2-ethylhexyl,

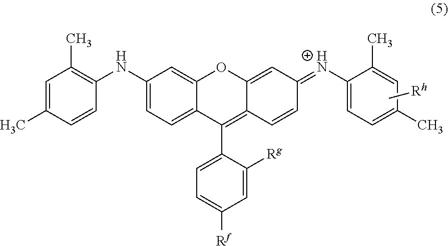

wherein

R^{f}, R^{g}, and R^{h} are independently selected from the group consisting of —SO₃⁻, —SO₃Na, and —SO₂NHR⁸; and

R⁸ represents 2-ethylhexyl,

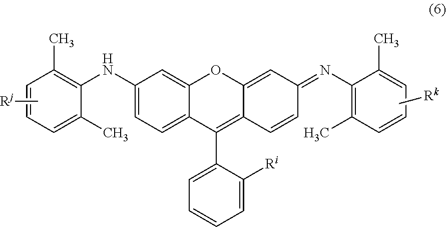

wherein

Rⁱ, R^{j}, and R^{k} are independently selected from the group consisting of hydrogen, —SO₃⁻, —SO₃H, and —SO₂NHR⁸; and

R⁸ represents 2-ethylhexyl,

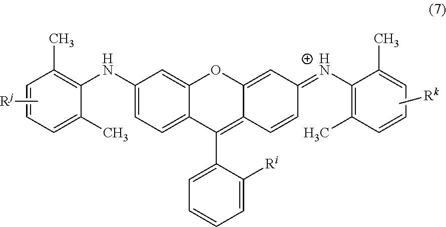

wherein

Rⁱ, R^{j}, and R^{k} are independently selected from the group consisting of hydrogen, —SO₃⁻, —SO₃H, and —SO₂NHR⁸; and

R⁸ represents 2-ethylhexyl,

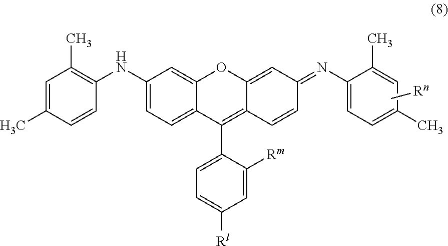

wherein

R^{l}, R^{m}, and Rⁿ are independently selected from the group consisting of —SO₃⁻, —SO₃Na, and —SO₂NHR⁸; and

R⁸ represents 2-ethylhexyl,

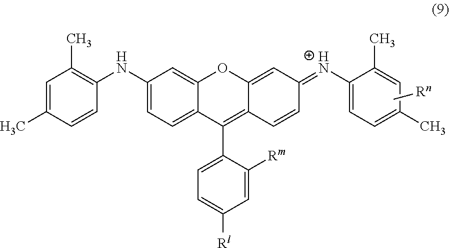

wherein

R^{l}, R^{m}, and Rⁿ are independently selected from the group consisting of —SO₃⁻, —SO₃Na, and —SO₂NHR⁸; and

R⁸ represents 2-ethylhexyl,

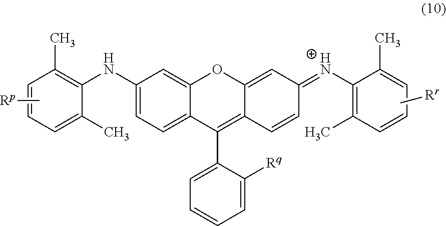

wherein

R^{p}, R^{q}, and R^{r} are independently selected, from the group consisting of hydrogen, —SO₃⁻, —SO₃H, and —SO₂NHR⁸; and

R⁸ represents 2-ethylhexyl,

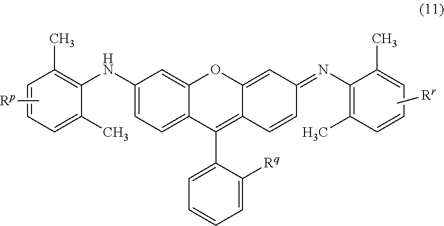

wherein

R^{p}, R^{q}, and R^{r} are independently selected from the group consisting of hydrogen, —SO₃⁻, —SO₃H, and —SO₂NHR⁸; and

R⁸ represents 2-ethylhexyl,

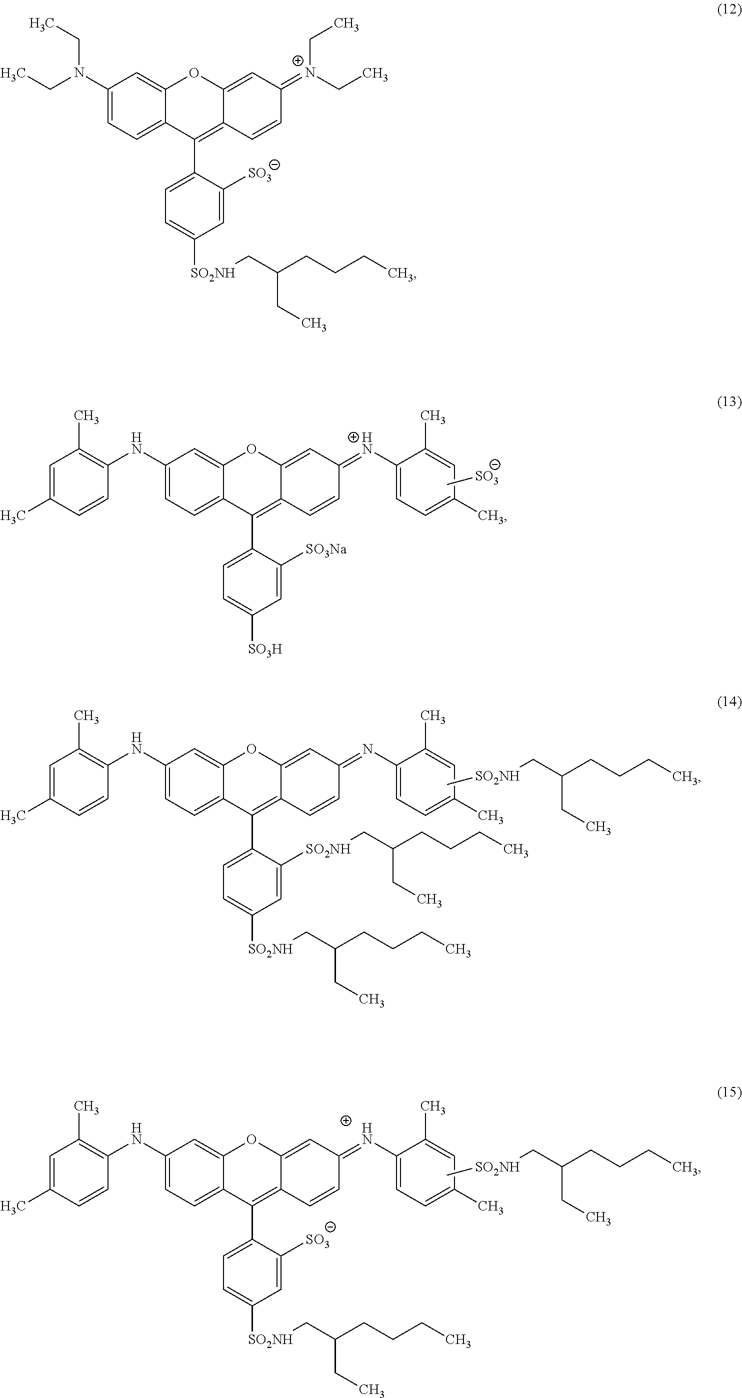

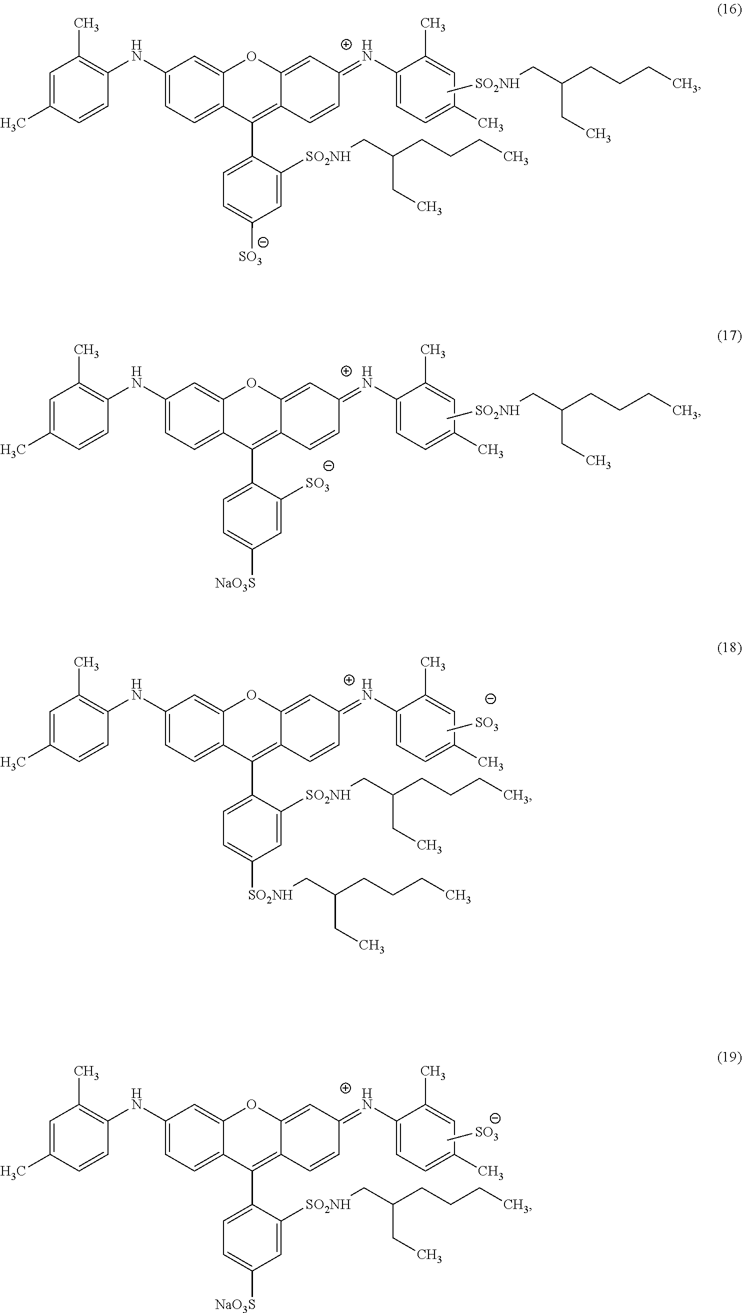

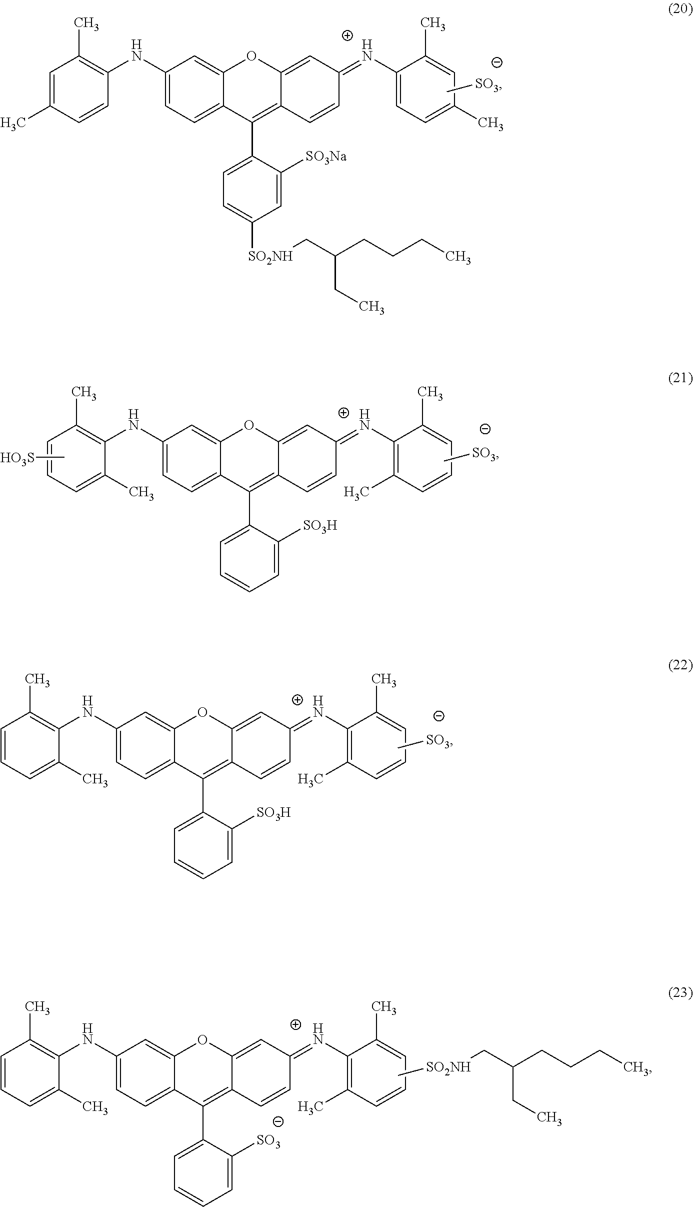

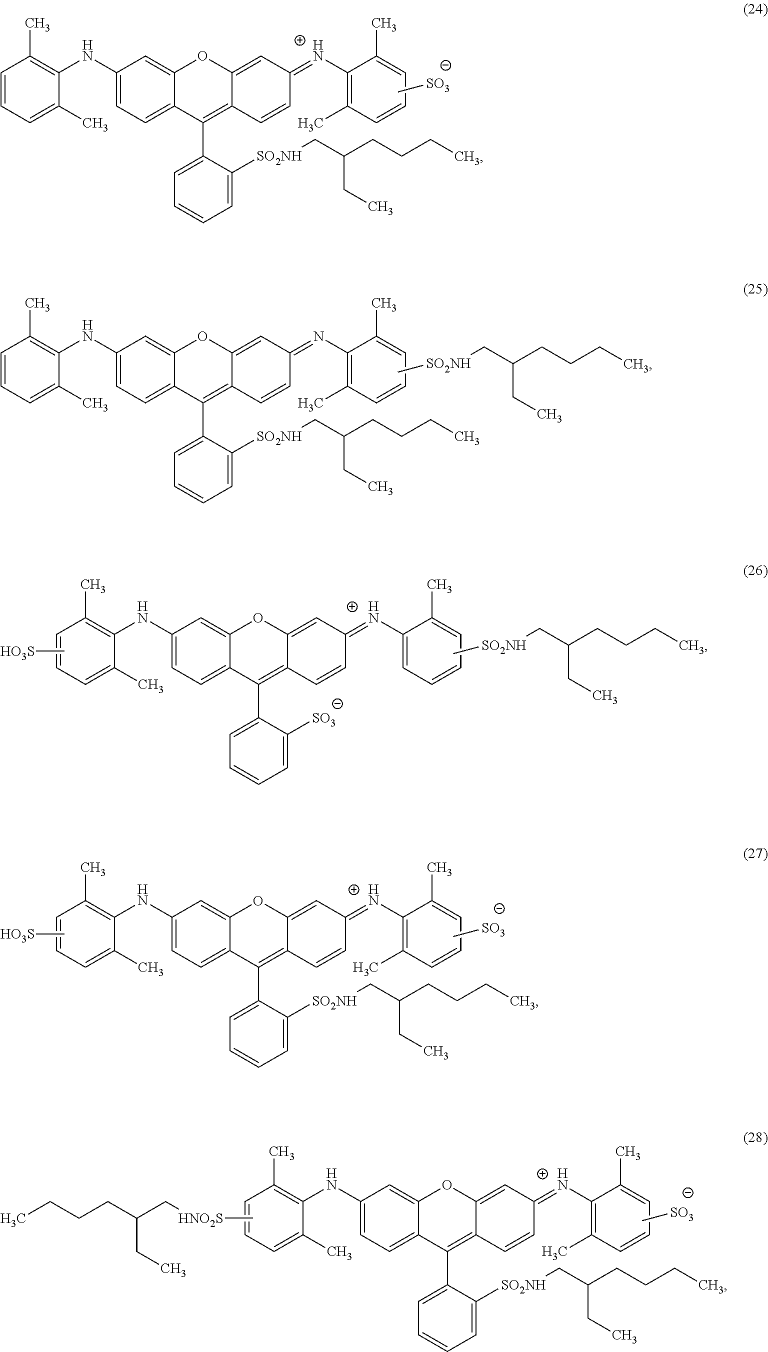

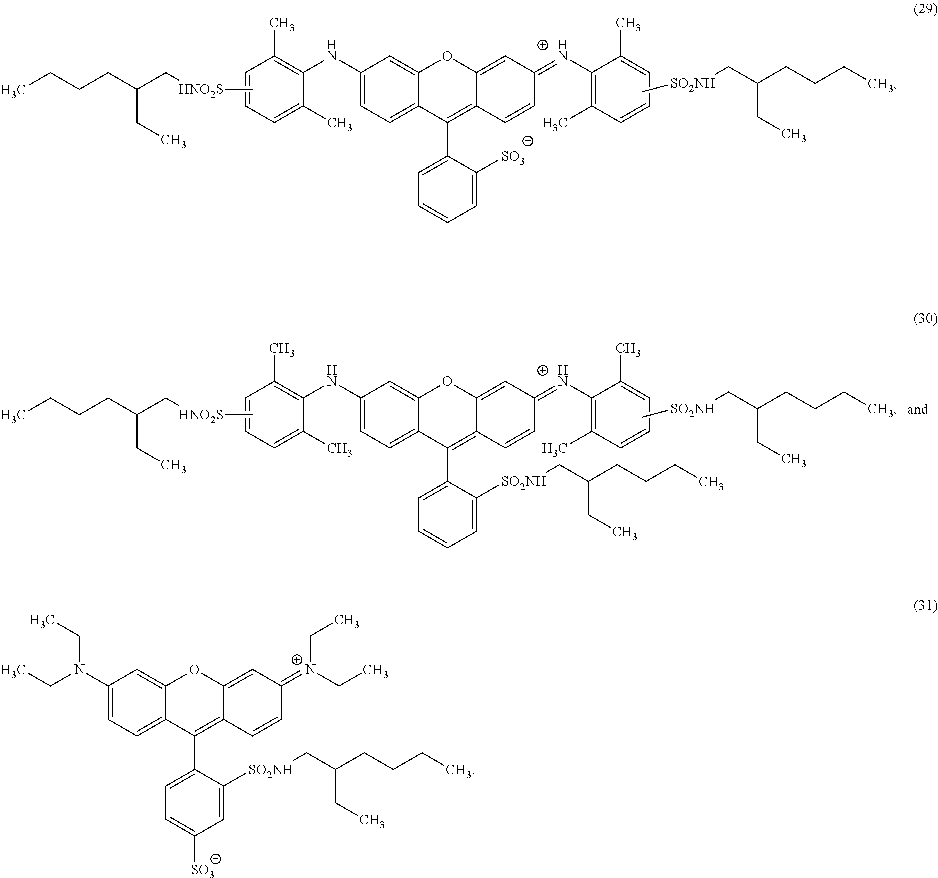

Preferred examples of the red dye component (B) include the compound of formula (I) where R^{c} and R^{d} are —SO₃⁻ and a is 0 (such as C.I. Acid Red 52), the compound of formula (22) (such as C.I. Acid Red 289), the compound of formula (28), the compound of formula (31), and combinations thereof.

More preferred examples of the red dye component (B) include C.I. Acid Red 52, C.I. Acid Red 289, the compound of formula (28), the compound of formula (31), and combinations thereof.

The weight ratio of the blue pigment component (A) to the red dye component (B) ranges from 0.1 to 100, preferably from 0.5 to 95, and more preferably from 1 to 90. The color liquid crystal display devices manufactured with the blue photosensitive resin composition have better color reproduction when the weight ratio of the blue pigment component (A) to the red dye component (B) falls within the aforesaid range. The red dye component (B) is used in an amount ranging from 0.5 part by weight to 50 parts by weight, preferably from 1 part by weight to 45 parts by weight, and more preferably from 2 parts by weight to 40 parts by weight based on 100 parts by weight of the alkali-soluble resin (C).

### <Alkali-Soluble Resin (C)>

The alkali-soluble resin (C) is obtainedby subjecting an ethylenically unsaturated monomer having one or more carboxyl groups and another copolymerizable ethylenically unsaturated monomer to conduct a copolymerization. Preferably, the amounts of the ethylenically unsaturated monomer having one or more carboxyl groups and the another copolymerizable ethylenically unsaturated monomer used in the copolymerization reaction are 50-95 wt % and 5-50 wt %, respectively.

Examples of the ethylenically unsaturated monomer having one or more carboxyl groups can be used alone or in admixture of two or more thereof, and include, but are not limited to, unsaturated monocarboxylic acids, such as acrylic acid, methacrylic acid, butenoic acid, α-chloroacrylic acid, ethacrylic acid, cinnamic acid, 2-acryloylethoxy succinate, 2-methacryloylethoxy succinate, or the like; unsaturated dicarboxylic acids and/or anhydrides thereof, such as maleic acid, maleic anhydride, fumaric acid, itaconic acid, itaconic anhydride, citraconic acid, citraconic anhydride, or the like; and unsaturated polycarboxylic acids having at least three carboxyl groups in the molecules and/or anhydrides thereof. Preferably, the ethylenically unsaturated monomer having one or more carboxyl groups is selected from acrylic acid, methacrylic acid, 2-acryloylethoxy succinate, and 2-methacryloylethoxy succinate. More preferably, the ethylenically unsaturated monomer having one or more carboxyl groups is selected from 2-acryloylethoxy succinate and 2-methacryloylethoxy succinate. The ethylenically unsaturated monomer having one or more carboxyl groups is used for increasing the pigment dispersion, enhancing the development speed, and reducing the residue.

Examples of the another copolymeriable ethylenically unsaturated monomer can be used alone or in admixture of two or more thereof, and include, but are not limited to, vinyl aromatic compounds, such as styrene, α-methyl styrene, vinyl toluene, p-chlorostyrene, methoxystyrene, or the like; maleimides, such as N-phenylmaleimide, N-o-hydroxyphenylmaleimide, N-m-hydroxyphenylmaleimide, N-p-hydroxyphenylmaleimide, N-o-methylphenylmaleimide, N-m-methylphenylmaleimide, N-p-methylphenylmaleimide, N-o-methoxyphenylmaleimide, N-m-methoxyphenylmaleimide, N-p-methoxyphenylmaleimide, N-cyclohexylmaleimide, or the like; unsaturated carboxylates, such as methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tetradecyl methacrylate, cetyl methacrylate, octadecyl methacrylate, eicosyl methacrylate, docosyl methacrylate, dicyclopentenyloxyethyl acrylate, or the like; N,N-dimethyl aminoethyl acrylate, N,N-dimethyl aminoethyl methacrylate, N,N-diethyl aminopropyl acrylate, N,N-dimethyl aminopropyl methacrylate, N,N-dibutyl aminopropyl acrylate, isobutylaminoethyl N-methylacrylate, or the like; unsaturated glycidyl carboxylates, such as glycidyl acrylate, glycidyl methacrylate, or the like; vinyl carboxylates, such as vinyl acetate, vinyl propionate, vinyl butyrate, or the like; unsaturated ethers, such as vinyl methyl ether, vinyl ethyl ether, allyl glycidyl ether, methallyl glycidyl ether, or the like; vinyl cyanides, such as acrylonitrile, methyl acrylonitrile, α-chloroacrylonitrile, vinylidene cyanide, or the like; unsaturated amides, such as acrylamide, methacrylamide, α-chloroacrylamide, N-hydroxyethyl acrylamide, N-hydroxyethyl methacrylamide, or the like; and aliphatic conjugate dienes, such as 1,3-butadiene, isoprene, chloroprene, or the like.

Preferably, the another copolymerizable ethylenically unsaturated monomer is selected from styrene, N-phenylmaleimide, methyl acrylate, methyl methacrylate, 2-hydroxyethyl acrylate, 2-hydroxyethyl methacrylate, benzyl acrylate, benzyl methacrylate, dicyclopentenyloxyethyl acrylate, and combinations thereof.

Examples of the solvent suitable for preparing the alkali-soluble resin (C) can be used alone or in admixture of two or more thereof, and include, but are not limited to, (poly)alkylene glycol monoalkyl ethers, such as ethylene glycol methyl ether, ethylene glycol ethyl ether, diethylene glycol methyl ether, diethylene glycol ethyl ether, diethylene glycol n-propyl ether, diethylene glycol n-butyl ether, triethylene glycol methyl ether, triethylene glycol ethyl ether, propylene glycol methyl ether, propylene glycol ethyl ether, dipropylene glycol methyl ether, dipropylene glycol ethyl ether, dipropylene glycol n-propyl ether, dipropylene glycol n-butyl ether, tripropylene glycol methyl ether, tripropylene glycol ethyl ether, or the like; (poly)alkylene glycol monoalkyl ether acetates, such as ethylene glycol methyl ether acetate, ethylene glycol ethyl ether acetate, propylene glycol methyl ether acetate, propylene glycol ethyl ether acetate, or the like; other ethers, such as diethylene glycol dimethyl ether, diethylene glycol methyl ethyl ether, diethylene glycol diethyl ether, tetrahydrofuran, or the like; ketones, such as methyl ethyl ketone, cyclohexanone, 2-heptanone, 3-heptanone, or the like; alkyl lactate, such as methyl 2-hydroxypropionate, ethyl 2-hydroxypropionate, or the like; other esters, such as methyl 2-hydroxy-2-methylpropionate, ethyl 2-hydroxy-2-methylpropionate, methyl 3-methoxypropionate, ethyl 3-methoxypropionate, methyl 3-ethoxypropionate, ethyl 3-ethoxypropionate, ethyl ethoxy acetate, ethyl hydroxy acetate, methyl 2-hydroxy-3-methylbutyrate, 3-methyl-3-methoxybutyl acetate, 3-methyl-3-methoxybutyl propionate, ethyl acetate, n-propyl acetate, iso-propyl acetate, n-butyl acetate, iso-butyl acetate, n-amyl acetate, iso-amyl acetate, n-butyl propionate, ethyl butyrate, n-propyl butyrate, iso-propyl butyrate, n-butyl butyrate, methyl pyruvate, ethyl pyruvate, n-propyl pyruvate, methyl acetoacetate, ethyl acetoacetate, ethyl 2-Methoxybutyrate, or the like; aromatic hydrocarbons, such as toluene, xylene, or the like; and carboxylic acid amide, such as N-methyl-2-pyrrolidone, N,N-dimethylformamide, N,N-dimethylacetamide, or the like. Preferably, the solvent is selected from propylene glycol methyl ether acetate, ethyl 3-ethoxypropionate, and a combination thereof. Examples of the (poly)alkylene glycol monoalkyl ethers include alkylene glycol monoalkyl ethers and polyalkylene glycol monoalkyl ethers. Examples of the (poly)alkylene glycol monoalkyl ether acetates include alkylene glycol monoalkyl ether acetates and polyalkylene glycol monoalkyl ether acetates.

The initiator used for preparing the alkali-soluble resin (C) is a free radical polymerization initiator, examples of which include, but are not limited to, azo compounds, such as 2,2′-azobisisobutyronitrile, 2,2′-azobis-(2,4-dimethylvaleronitrile), 2,2′-azobis-(4-methoxy-2,4-dimethylvaleronitrile), 2,2′-azobis-2-methylbutyronitrile, or the like; and peroxides, such as benzoyl peroxide, or the like.

### <Compound Having at Least One Ethylenically Unsaturated Group (D)>

The compound having at least one ethylenically unsaturated group (D) used in the present invention is a compound having one or more ethylenically unsaturated groups.

Examples of the compound having one ethylenically unsaturated group can be used alone or in admixture of two or more thereof, and include, but are not limited to, acrylamide, acryloylmorpholine, methylacryloylmorpholine, 7-amino-3,7-dimethyloctyl acrylate, 7-amino-3,7-dimethyloctyl methylacrylate, iso-butoxymethyl acrylamide, iso-butoxymethyl methylacrylamide, iso-bornyloxyethyl acrylate, iso-bornyloxyethyl methylacrylate, iso-bornyl acrylate, iso-bornyl methylacrylate, 2-ethylhexyl acrylate, 2-ethylhexyl methylacrylate, ethyl diethylene glycol acrylate, ethyl diethylene glycol methylacrylate, t-octyl acrylamide, t-octyl methylacrylamide, diacetone acrylamide, diacetone methylacrylamide, dimethylaminoethyl acrylate, dimethylaminoethyl methylacrylate, dodecyl acrylate, dodecyl methylacrylate, dicyclopentenyloxyethyl acrylate, dicyclopentenyloxyethyl methylacrylate, dicyclopentenyl acrylate, dicyclopentenyl methylacrylate, N,N-dimethyl acrylamide, N,N-dimethyl methylacrylamide, tetrachlorophenyl acrylate, tetrachlorophenyl methylacrylate, 2-tetrachlorophenoxy ethyl acrylate, 2-tetrachlorophenoxy ethyl methylacrylate, tetrahydrofurfuryl acrylate, tetrahydrofurfuryl methylacrylate, tetrabromophenyl acrylate, tetrabromophenyl methylacrylate, 2-tetrabromophenoxyethyl acrylate, 2-tetrabromophenoxyethyl methylacrylate, 2-trichlorophenoxyethyl acrylate, 2-trichlorophenoxyethyl methylacrylate, tribromophenyl acrylate, tribromophenyl methylacrylate, 2-tribromophenoxyethylacrylate, 2-tribromophenoxyethyl methylacrylate, 2-hydroxyethyl acrylate, 2-hydroxyethyl methacrylate, 2-hydroxypropyl acrylate, 2-hydroxypropyl methylacrylate, vinylcaprolactam, N-vinylpyrrolidone, phenoxyethyl acrylate, phenoxyethyl methylacrylate, pentachlorophenyl acrylate, pentachlorophenyl methylacrylate, pentabromophenyl acrylate, pentabromophenyl methylacrylate, polyethylene glycol monoacrylate, polyethylene glycol monomethylacrylate, polypropylene glycol monoacrylate, polypropylene glycol monomethylacrylate, bornyl acrylate, and bornyl methylacrylate.

Examples of the compound having two or more ethylenically unsaturated groups can be used alone or in admixture of two or more thereof, and include, but are not limited to, ethylene glycol diacrylate, ethylene glycol dimethylacrylate, dicyclopentenyl diacrylate, dicyclopentenyl dimethylacrylate, triethylene glycol diacrylate, tetraethylene glycol diacrylate, tetraethylene glycol dimethylacrylate, tri(2-hydroxyethyl) isocyanate diacrylate, tri(2-hydroxyethyl) isocyanate dimethylacrylate, tri(2-hydroxyethyl) isocyanate triacrylate, tri(2-hydroxyethyl)isocyanate trimethylacrylate, caprolactone-modified tri(2-hydroxyethyl)isocyanate triacrylate, caprolactone-modified tri(2-hydroxyethyl) isocyanate trimethylacrylate, trimethylolpropyl triacrylate, trimethylolpropyl trimethylacrylate, ethylene oxide (hereinafter abbreviated as EO) modified trimethylolpropyl triacrylate, EO-modified trimethylolpropyl trimethylacrylate, propylene oxide (hereinafter abbreviated as PO) modified trimethylolpropyl triacrylate, PO-modified trimethylolpropyl trimethylacrylate, tripropylene glycol diacrylate, tripropylene glycol dimethylacrylate, neo-pentyl glycol diacrylate, neo-pentyl glycol dimethylacrylate, 1,4-butanediol diacrylate, 1,4-butanediol dimethylacrylate, 1,6-hexanediol diacrylate, 1,6-hexanediol dimethylacrylate, pentaerythritol triacrylate, pentaerythritol trimethylacrylate, pentaerythritol tetraacrylate, pentaerythritol tetramethylacrylate, polyester diacrylate, polyester dimethylacrylate, polyethylene glycol diacrylate, polyethylene glycol dimethylacrylate, dipentaerythritol hexaacrylate, dipentaerythritol hexamethylacrylate, dipentaerythritol pentaacrylate, dipentaerythritol pentamethylacrylate, dipentaerythritol tetraacrylate, dipentaerythritol tetramethylacrylate, caprolactone-modified dipentaerythritol hexaacrylate, caprolactone-modified dipentaerythritol hexamethylacrylate, caprolactone-modified dipentaerythritol pentaacrylate, caprolactone-modified dipentaerythritol pentamethylacrylate, ditrimethylolpropyl tetraacrylate, ditrimethylolpropyl tetramethylacrylate, EO-modified bisphenol A diacrylate, EO-modified bisphenol A dimethylacrylate, PO-modified bisphenol A diacrylate, PO-modified bisphenol A dimethylacrylate, EO-modified hydrogenated bisphenol A diacrylate, EO-modified hydrogenated bisphenol A dimethylacrylate, PO-modified hydrogenated bisphenol A diacrylate, PO-modified hydrogenated bisphenol A dimethylacrylate, PO-modified glycerol triacrylate, EO-modifiedbisphenolFdiacrylate, EO-modified bisphenol F dimethylacrylate, phenol novolac polyglycidyl ether acrylate, and phenol novolac polyglycidyl ether methylacrylate.

Preferably, the compound having at least one ethylenically unsaturated group (D) is selected from trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, caprolactone-modified dipentaerythritol hexaacrylate, ditrimethylolpropyl tetraacrylate, PO-modified glycerol triacrylate, and combinations thereof.

Preferably, the compound having at least one ethylenically unsaturated group (D) is used in an amount ranging from 10 to 500 parts by weight based on 100 parts by weight of the alkali-soluble resin (C).

### <Photoinitiator (E)>

Examples of the photoinitiator (E) can be used alone or in admixture of two or more thereof, and include, but are not limited to, O-acyloxime compounds, triazine compounds, acetophenone compounds, biimidazole compounds, and benzophenone compounds. Preferably, the photoinitiator (E) is used in amount ranging from 1 to 200 parts by weight based on 100 parts by weight of the alkali-soluble resin (C).

Examples of the O-acyloxime compounds can be used alone or in admixture of two or more thereof, and include, but are not limited to, 1-[4-(phenylthio)phenyl]-heptane-1,2-dione 2-(O-benzoyloxime), 1-[4-(phenylthio)phenyl]-octane-1,2-dione 2-(O-benzoyloxime), 1-[4-(benzoyl)phenyl]-heptane-1,2-dione 2-(O-benzoyloxime), 1-[9-ethyl-6-(2-methylbenzoyl)-9H-carbazol-3-yl]-ethylketo 1-(O-acetyloxime), 1-[9-ethyl-6-(3-methylbenzoyl)-9H-carbazol-3-yl]-ethylketo 1-(O-acetyloxime), 1-[9-ethyl-6-benzoyl-9H-carbazol-3-yl]-ethylketo 1-(O-acetyloxime), ethylketo-1-[9-ethyl-6-(2-methyl-4-tetrahydrofurylbenzoyl)-9H-carbazol-3-yl]-1-(O-acetyloxime), ethylketo-1-[9-ethyl-6-(2-methyl-5-tetrahydropyranylbenzoyl)-9H-carbazol-3-yl]-1-(O-acetyloxime), ethylketo-1-[9-ethyl-6-(2-methyl-4-tetrahydrofurylmethoxybenzoyl)-9H-carbazol-3-yl]-1-(O-acetyloxime), ethylketo-1-[9-ethyl-6-(2-methyl-5-tetrahydrofurylmethoxybenzoyl)-9H-carbazol-3-yl]-1-(O-acetyloxime), ethylketo-1-[9-ethyl-6-[2-methyl-4-(2,2-dimethyl-1,3-dioxolyl)benzoyl]-9H-carbazol-3-yl]-1-(O-acetyloxime), and ethylketo-1-[9-ethyl-6-{2-methyl-4-(2,2-dimethyl-1,3-dioxolyl)methoxybenzoyl}-9H-carbazol-3-yl]-1-(O-acetyloxime).

Examples of the triazine compounds can be used alone or in admixture of two or more thereof, and include, but are not limited to, 2,4-bis(trichloromethyl)-6-(p-methoxy)styryl-s-triazine, 2,4-bis(trichloromethyl)-6-(1-p-dimethylaminophenyl-1,3-butadienyl)-s-triazine, and 2-trichloromethyl-4-amino-6-(p-methoxy)styryl-s-triazine.

Examples of the acetophenone compounds can be used alone or in admixture of two or more thereof, and include, but are not limited to, p-dimethylaminoacetophenone, α,α′-dimethoxyazoxyacetophenone, 2,2′-dimethyl-2-phenylacetophenone, p-methoxyacetophenone, 2-methyl-1-(4-methylthiophenyl)-2-morpholino-1-propanone, and 2-benzyl-2-N,N-dimethylamino-1-(4-morpholinophenyl)-1-butanone.

Examples of the biimidazole compounds can be used alone or in admixture of two or more thereof, and include, but are not limited to, 2,2′-bis(o-chlorophenyl)-4,4′,5,5′-tetraphenylbiimidazole, 2,2′-bis(o-fluorophenyl)-4,4′,5,5′-tetraphenylbiimidazole, 2,2′-bis(o-methylphenyl)-4,4′,5,5′-tetraphenylbiimidazole, 2,2′-bis(o-methoxyphenyl)-4,4′,5,5′-tetraphenylbiimidazole, 2,2′-bis(o-ethylphenyl)-4,4′,5,5′-tetraphenylbiimidazole, 2,2′-bis(p-methoxyphenyl)-4,4′,5,5′-tetraphenylbiimidazole, 2,2′-bis(2,2′,4,4′-tetramethoxyphenyl)-4,4′,5,5′-tetraphenylbiimidazole, 2,2′-bis(2-chlorophenyl)-4,4′,5,5′-tetraphenylbiimidazole, and 2,2′-bis(2,4-dichlorophenyl)-4,4′,5,5′-tetraphenylbiimidazole.

Examples of the benzophenone compounds can be used alone or in admixture of two or more thereof, and include, but are not limited to, thioxanthone, 2,4-diethylthioxanthone, thioxanthone-4-sulfone, benzophenone, 4,4′-bis(dimethylamino)benzophenone, and 4,4′-bis(diethylamino)benzophenone.

Preferably, the photoinitiator (E) is selected from 1-[4-(phenylthio)phenyl]-octane-1,2-dione 2-(O-benzoyloxime), 1-[9-ethyl-6-(2-methylbenzoyl)-9H-carbazol-3-yl]-ethylketo 1-(O-acetyloxime), ethylketo-1-[9-ethyl-6-(2-methyl-4-tetrahydrofurylmethoxybenzoyl)-9H-carbazol-3-yl]-1-(O-acetyloxime), ethylketo-1-[9-ethyl-6-{2-methyl-4-(2,2-dimethyl-1,3-dioxolyl)methoxybenzoyl}-9H-carbazol-3-yl]-1-(O-acetyloxime), 2,4-bis(trichloromethyl)-6-(p-methoxy)styryl-s-triazine, 2-benzyl-2-N,N-dimethylamino-1-(4-morpholinophenyl)-1-butanone, 2,2′-bis(2,4-dichlorophenyl)-4,4′,5,5′-tetraphenylbiimidazole, 4,4′-bis(diethylamino)benzophenone, and combinations thereof.

In addition to the aforesaid photoinitiators (E), other initiators can be further added into the blue photosensitive resin composition of the present invention provided that the desirable physical properties of the blue photosensitive resin composition are not affected. Examples of the other initiators include α-diketone compounds, acyloin compounds, acyloin ether compounds, acylphosphineoxide compounds, quinine compounds, halide compounds, peroxide compounds, or the like.

Examples of the α-diketone compounds can be used alone or in admixture of two or more thereof, and include, but are not limited to, benzil and acetyl compounds.

Examples of the acyloin compounds can be used alone or in admixture of two or more thereof, and one of the examples thereof is benzoin.

Examples of the acyloin ether compounds can be used alone or in admixture of two or more thereof, and include, but are limited to, benzoin methylether, benzoin ethylether, and benzoin isopropyl ether.

Examples of the acylphosphine oxide compounds can be used alone or in admixture of two or more thereof, and include, but are not limited to, 2,4,6-trimethylbenzoyl diphenylphosphine oxide, and bis-(2,6-dimethoxybenzoyl)-2,4,4-trimethyl benzyl phosphine oxide.

Examples of the quinone compounds can be used alone or in admixture of two or more thereof, and include, but are not limited to, anthraquinone and 1,4-naphthoquinone.

Examples of the halide compounds can be used alone or in admixture of two or more thereof, and include, but are not limited to, phenacyl chloride, tribromomethyl phenylsulfone, and tris(trichloromethyl)-s-triazine.

Examples of the peroxide compounds can be used alone or in admixture of two or more thereof, and one of the examples thereof is di-tert-butyl peroxide.

### <Solvent (F)>

The blue photosensitive resin composition of this invention is prepared by dissolving all the above components other than the blue pigment component (A) in the solvent (F) to prepare a liquid composition followed by homogeneously mixing the liquid composition with the blue pigment component (A). The solvent (F) must be able to dissolve the alkali-soluble resin (C), the compound having at least one ethylenically unsaturated group (D), and the photoinitiator (E). Also, the solvent (F) must not be able to react with the components dissolved therein, and has proper volatility. The solvent (F) is used in an amount ranging from 50 to 5,000 parts by weight based on 100 parts by weight of the alkali-soluble resin (C).

The solvent (F) suitable for preparing the blue photosensitive resin composition can be selected from the examples of the solvent for preparing the alkali-soluble resin (C). Preferably, the solvent (F) suitable for preparing the blue photosensitive resin composition is selected from propylene glycol methyl ether acetate and ethyl 3-ethoxypropionate.

### <Functional Additives (G)>

The blue photosensitive resin composition of the present invention can contain other functional additives (G), such as fillers, polymers other than the alkali-soluble resin (C), adhesion-promoting agents, antioxidants, UV absorbents, anti-coagulants, or the like so as to provide the blue filter segment made from the blue photosensitive resin composition with specifically required physical and chemical properties. The aforesaid examples of the functional additives (G) can be used alone or in admixture of two or more thereof.

Examples of the fillers include glass, aluminum, or the like. Examples of the polymers other than the alkali-soluble resin (C) include polyvinyl alcohol, polyethylene glycol monoalkyl ether, polyfluoro alkyl acrylate, or the like. Examples of the adhesion-promoting agents include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidyloxypropyltrimethoxysilane, 3-glycidyloxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryl oxypropyltrimethoxysilane, 3-mercaptopropyltrimethoxysilane, or the like. Examples of the antioxidants include 2,2-thiobis(4-methyl-6-t-butylphenol), 2,6-di-t-butylphenol, or the like. Examples of the UV absorbents include 2-(3-t-butyl-5-methyl-2-hydroxyphenyl)-5-chlorobenzotriazole, alkoxybenzophenone, or the like. Examples of the anti-coagulants include sodium polyacrylate, or the like.

### [Red Photosensitive Resin Composition]

The red filter segment in the present invention can be made of a conventional red photosensitive resin composition. In this example, the components of the red photosensitive resin composition are substantially identical to those of the blue photosensitive resin composition except that instead of the blue pigment component (A) used in the blue photosensitive resin composition, a red pigment combination is used in the red photosensitive resin composition.

The red pigment combination may include a first red pigment component having an azo condensation structure, a second red pigment component having an anthraquinone structure, or a combination thereof. Examples of the first red pigment component can be used alone or in admixture of two or more thereof, and include, but are not limited to, C.I. Pigment Red 83, C.I. Pigment Red 89, and C.I. Pigment Red 177. Preferably, the first red pigment component is selected from C.I. Pigment Red 89, C.I. Pigment Red 177, and a combination thereof.

Examples of the second red pigment component can be used alone or in admixture of two or more thereof, and include, but are not limited to, C.I. Pigment Red 144, C.I. Pigment Red 166, C.I. Pigment Red 214, C.I. Pigment Red 220, C.I. Pigment Red 221, C.I. Pigment Red 242, C.I. Pigment Red 248, and C.I. Pigment Red 262. Preferably, the second red pigment component is selected from C.I. Pigment Red 166, C.I. Pigment Red 242, and a combination thereof.

In order to adjust chromaticity, the red pigment combination can further include a third red pigment component and a yellow pigment component. Preferably, the third red pigment component is selected from quinacridone pigments, perylene pigments, pyranthrene-8,16-dione pigments, and combinations thereof. Preferably, the yellow pigment component is selected from isoindole pigments, quinophthalone pigments, azo pigments, and combinations thereof. More preferably, the yellow pigment component is a quinophthalone pigment. In view of color purity and transparency, the yellow pigment component is preferably selected from C.I. Pigment Yellow 83, C.I. Pigment Yellow 138, C.I. Pigment Yellow 139, C.I. Pigment Yellow 150, C.I. Pigment Yellow 185, C.I. Pigment Yellow 219, and combinations thereof.

### [Green Photosensitive Resin Composition]

The green filter segment in the present invention can be made of a conventional green photosensitive resin composition. In this example, the components of the green photosensitive resin composition are substantially identical to those of the blue photosensitive resin composition except that instead of the blue pigment component (A) used in the blue photosensitive resin composition, a green pigment combination is used in the green photosensitive resin composition. The green pigment combination includes a halogenated-phthalocyanine-based green pigment and a yellow pigment.

Examples of the halogenated-phthalocyanine-based green pigment include, but are not limited to, C.I. Pigment Green 7, C.I. Pigment Green 36, C.I. Pigment Green 37, C.I. Pigment Green 42, C.I. Pigment Green 58, and combinations thereof.

Preferably, the yellow pigment is selected from C.I. Pigment Yellow 1, C.I. Pigment Yellow 3, C.I. Pigment Yellow 10, C.I. Pigment Yellow 12, C.I. Pigment Yellow 13, C.I. Pigment Yellow 14, C.I. Pigment Yellow 17, C.I. Pigment Yellow 20, C.I. Pigment Yellow 24, C.I. Pigment Yellow 31, C.I. Pigment Yellow 55, C.I. Pigment Yellow 81, C.I. Pigment Yellow 83, C.I. Pigment Yellow 93, C.I. Pigment Yellow 94, C.I. Pigment Yellow 97, C.I. Pigment Yellow 109, C.I. Pigment Yellow 110, C.I. Pigment Yellow 128, C.I. Pigment Yellow 138, C.I. Pigment Yellow 139, C.I. Pigment Yellow 150, C.I. Pigment Yellow 153, C.I. Pigment Yellow 154, C.I. Pigment Yellow 155, C.I. Pigment Yellow 166, C.I. Pigment Yellow 167, C.I. Pigment Yellow 168, C.I. Pigment Yellow 180, C.I. Pigment Yellow 185, C.I. Pigment Yellow 211, C.I. Pigment Yellow 219, and combinations thereof. More preferably, the yellow pigment is selected form C.I. Pigment Yellow 138, C.I. Pigment Yellow 139, C.I. Pigment Yellow 150, and combinations thereof.

### [Color Filter]

The blue photosensitive resin composition in a liquid state for the color filter of the present invention can be formed by blending the alkali-soluble resin (C), the compound having at least one ethylenically unsaturated group (D), the photoinitiator (E), the red dye component (B), and the blue pigment component (A) in the solvent (F) using a mixer. The blue photosensitive resin composition is coated on a substrate by a spin coating method, a knife coating method, an ink-jet coating method, a roller coating method, or the like, and is then dried under reduced pressure to remove most of the solvent. After completely evaporating the residual solvent bypre-baking, a coating film is formed. The operating conditions for the drying under reduced pressure and the pre-baking depend on the kinds and the amounts of the components used in the blue photosensitive resin composition. In general, the drying under reduced pressure is carried out at a pressure from 0 to 200 mm Hg for a period from 1 to 60 seconds. The pre-baking is carried out at a temperature from 70° C. to 110° C. for a period from 1 to 15 minutes. The coating film is then exposed to UV light through a specific photo mask, and is developed in a developer solution at a temperature of 23±2° C. for a period from 15 seconds to 5 minutes to dissolve and remove the undesirable portions of the coating film so as to obtain a desired pattern. The substrate with the desired pattern of the coating film is washed with water, is dried with compressed air or compressed nitrogen, and is heated at a temperature from 100° C. to 280° C. for a period of 1 to 15 minutes in a heating device, such as a hot plate or an oven so as to remove evaporative components and to subject the unreacted ethylenically unsaturated compound contained in the coating film to conduct a heat curing reaction. The blue filter segment can be obtained thereby. The red and green filter segments can be obtained using the red and green photosensitive resin compositions, respectively, following the procedure for making the blue filter segment. A color filter with blue, green and red filter segments can be obtained thereby. It is noted that the order of forming blue, green and red filter segments is not limited to the aforementioned procedure.

The UV light used for the exposure of the coating film can be g line, h line, i line, or the like. The UV lamp for providing the UV light is a (ultra)high-pressure mercury lamp or a metal halide lamp. The substrate used to form the color filter is made from bare glass, soda glass, Pyrex glass, silica glass, or any one of these glass coated with a transparent conductive film, or an electrode substrate (for example, a silicon substrate) used in solid state image pick up devices. A black matrix to separate the color filter segments from each other is formed on the substrate in advance.

Examples of the developer solution include, but are not limited to, an alkali aqueous solution of sodium hydroxide, potassium hydroxide, sodium carbonate, sodium hydrogen carbonate, potassium carbonate, potassium hydrogen carbonate, sodium silicate, sodium methylsilicate, aqueous ammonia, ethylamine, diethylamine, dimethyl ethanolamine, tetramethylammonium hydroxide, tetraethylammonium hydroxide, choline, pyrrole, piperidine, 1,8-diaza-bicyclo(5,4,0)-7-undecene, or the like. The concentration of the developer in the solution is from 0.001 to 10 wt %, preferably from 0.005 to 5 wt %, and more preferably from 0.01 to 1 wt %.

### [Color Liquid Crystal Display Device]

A color liquid crystal display device is made by connecting the liquid crystal display element having the color filter with the backlight unit. The method of connecting the liquid crystal display element with the backlight unit is well known and is not a feature of this invention. Therefore, further details are omitted herein for the sake of brevity.

### [Liquid Crystal Display Element]

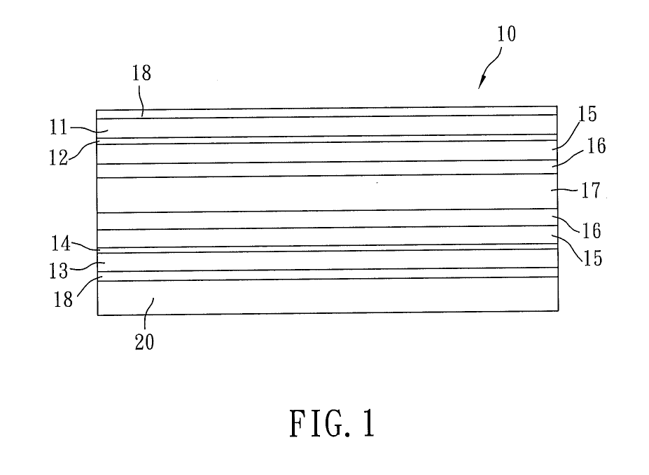

Referring to FIG. 1, the color liquid crystal display device of this invention includes a liquid crystal display element 10 and a backlight unit 20.

The liquid crystal display element 10 in this invention includes a first substrate 11, a color filter 12 formed on a surface of the first substrate 11, a second substrate spaced apart from the color filter 12, a thin-film transistor 14 formed on a surface of the second substrate 13 and spaced apart from the color filter 12, two conducting layers 15 respectively formed on a surface of the color filter 12 and a surface of the thin-film transistor 14, two alignment layers 16 formed respectively on surfaces of the two conducting layers 15, a liquid crystal layer 17 disposed between the alignment layers 16, and two polarizers 18 respectively coupled to the first and second substrates 11, 13, and distal from the alignment layers 16. The alignment layers 16 are composed of polyimide polymer while the conducting layers 15 are composed of indium tin oxide (abbreviated as ITO). Spacers (not shown) are formed on the alignment layers 16. The conducting layers 15 can be etched and formed with a wiring layout, if necessary. The general configuration of the liquid crystal display device is well known and is not a feature of this invention. Therefore, further details are omitted herein for the sake of brevity.

The liquid crystal layer 17 in this invention can be one using twisted nematic liquid crystal, super twisted nematic liquid crystal, in-plane switching liquid crystal, vertical alignment liquid crystal, optically compensated birefringence liquid crystal, ferroelectric liquid crystal, or the like. The manufacturing process of the liquid crystal display device 10 is well known and is not a feature of this invention. Therefore, further details are omitted herein for the sake of brevity.

### [Backlight Unit]

The backlight unit 20 is connected to the polarizer 18 formed on the second substrate 13 of the liquid crystal display element 10, and is capable of emitting light with a color temperature ranging from 8,000 to 20,000 K. Preferably, the backlight unit 20 is selected from a white light emitting diode, a trichrome fluorescent lamp, and a combination thereof.

### <White Light Emitting Diode>

In the light-emitting mechanism for the white light emitting diode used as the backlight unit 20, blue light emitted from a light-emitting layer of a light-emitting die is absorbed by photoluminescent phosphor and is then converted into light of another color. Some energy is lost during the conversion. When the backlight unit 20 is a white light emitting diode with a color temperature below 8,000 K, the color temperature of the color liquid crystal display device is lowered and is not satisfactory for the characteristic requirements for the liquid crystal display television. When the color temperature of the white light emitting diode is above 20,000 K, the color reproduction of the color liquid crystal display device is inferior.

Preferably, the white light emitting diode having a light emitting layer with a main peak spectrum ranging from 430 nm to 500 nm and a photoluminescent phosphor is used as the backlight unit. The material for the light emitting layer is selected from a nitride compound semiconductor, a group III-V compound semiconductor, group II-IV compound semiconductor, a group IV-VI compound semiconductor, and combinations thereof. Preferably, the light emitting layer is made of InGaN or GaN material, and is used in combination with the photoluminescent phosphor so as to reach the desired color temperature for the backlight unit 20.

Specifically, when the white light emitting diode is used as the backlight unit 20, a light-emitting layer of a blue light emitting die is formed with a fluorescence filter film containing the photoluminescent phosphor on a surface thereof, or a package material of the blue light emitting die contains the photoluminescent phosphor. Preferably, the photoluminescent phosphor is selected from yellow phosphor, green phosphor, red phosphor, and combinations thereof.

Preferably, the yellow phosphor is selected from cerium activated aluminum garnet phosphor, europium activated alkaline earth metal silicate phosphor, and a combination thereof. The cerium activated aluminum garnet phosphor is selected from RE₃ (Al, Ga)₅O₁₂:Ce, (Tb,Al)₅O₁₂:Ce, and a combination thereof, wherein RE is selected from Y, Gd, La, and combinations thereof. The europium activated alkaline earth metal silicate phosphor is selected from AE₂SiO₄:Eu, Sr₃SiO₅:Eu²⁺, and a combination thereof, wherein AE is selected from Sr, Ba, Ca, and combinations thereof.

Preferably, the green phosphor is selected from cerium activated phosphor, europium activated alkaline earth metal silicate phosphor, and a combination thereof. The cerium activated phosphor is selected from RE₃ (Al, Ga)₅O₁₂:Ce, Ca₃Sc₂O₄:Ce, and a combination thereof, wherein RE is selected from Y, Gd, La, and combinations thereof. The europium activated alkaline earth metal silicate phosphor is selected from AE₂SiO₄:Eu, Ca₃Sc₂Si₃O₁₂:Eu, and a combination thereof, wherein AE is selected from Sr, Ba, Ca, and combinations thereof.

Preferably, the red phosphor is selected from europium activated oxide, europium activated sulfide, europium activated nitride, and combinations thereof. Preferably, the europium activated oxide is Y₂O₃:Eu. The europium activated sulfide is selected from Y₂O₂S:Eu, La₂O₂S:Eu, and a combination thereof. The europium activated nitride is selected from AE₂Si₅N₈: Eu²⁺, CaAlSiN₃: Eu²⁺, CaAlSiBN₃:Eu, and combinations thereof, wherein AE is selected from Sr, Ba, Ca, and combinations thereof.

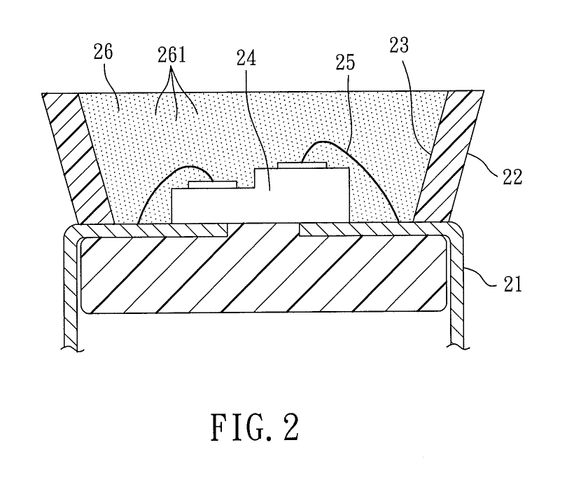

Referring to FIG. 2, the white color light emitting diode includes a lead frame 21, a surrounding wall 22 formed on the lead frame 21, a receiving space 23 defined by the lead frame 21 and the surrounding wall 22, a light emitting die 24 mounted in the receiving space 23 and connected to the lead frame 21, wires 25 for connecting the light emitting die 24 to the lead frame 21, and an encapsulant 26 filled in the receiving space 23 and encapsulating the light emitting die 24. The light emitting die 24 has a main emitting wavelength of 460 nm, and can be electrically connected to external electric circuits through the lead frame 21 and the wires 25. The encapsulant 26 is made from a polysiloxane resin containing photoluminescent phosphor 261 and is heat treated at 70° C. for 3 hours and then at 150° C. for 1 hour so as to be cured.

### <Trichrome Fluorescent Lamp>

When the trichrome fluorescent lamp with a color temperature lower than 8,000K or higher than 20,000K is used as the backlight unit 20, the color liquid crystal display device suffers from deteriorated color reproduction.

The trichrome fluorescent lamp includes a phosphor combination including a blue phosphor, a green phosphor, and a red phosphor. If the amount of the blue phosphor is increased, the light emitted by the trichrome fluorescent lamp is bluish white, and the color temperature of the backlight unit 20 is increased. If the amount of the red phosphor is increased, the light emitted by the trichrome fluorescent lamp is reddish white, and the color temperature of the backlight unit 20 is decreased. In view of the color temperature, the blue phosphor is selected from Sr₅(PO₄)₃Cl:Eu, (SrCaBa)₅(PO₄)₃Cl:Eu, BaMg₂Al₁₆O₂₇:Eu, and combinations thereof, the green phosphor is selected from LaPO₄:Ce, Tb, (CeTb)MgAl₁₄O₁₉, and a combination thereof, and the red phosphor is Y₂O₃:Eu. Preferably, the blue phosphor is in an amount ranging from 20 to 55 wt %, the green phosphor is in an amount ranging from 20 to 55 wt %, and the red phosphor is in an amount ranging from 20 to 45 wt % based on a total weight of the phosphor combination.

### EXAMPLES

The following examples are provided to illustrate the preferred embodiments of the invention, and should not be construed as limiting the scope of the invention.

### Synthesis Example

### Preparation of Alkali-Soluble Resin (C)

### Synthesis Example 1

A 1000 ml four-necked conical flask equipped with a nitrogen inlet, a stirrer, a heater, a condenser and a thermometer was purged with nitrogen, and was added with 45 parts by weight of 2-methacryloylethoxy succinate, 40 parts by weight of styrene, 15 parts by weight of dicyclopentenyloxyethyl acrylate, and 200 parts by weight of ethyl 3-ethoxypropionate. The ingredients were continuously added into the four-necked conical flask with stirring in an oil bath of 100° C. 4 parts by weight of 2,2′-azobis-2-methyl butyronitrile was dissolved into ethyl 3-ethoxypropionate, divided equally into five portions, and added into the four-necked conical flask portionwise within an hour. Polymerization was conducted at 100° C. for 6 hours, and a polymerization product was then taken out of the conical flask followed by removal of solvent from the product so as to obtain an alkali-soluble resin (C-1).

### Synthesis Examples 2 and 3

Synthesis Examples 2 and 3 were conducted in a manner identical to that of Synthesis Example 1 with different reaction conditions as well as altered ingredients and amounts which are illustrated in Table 1.

### Preparation Example

### Preparation of Blue Photosensitive Resin Composition

### Preparation Example a

90 parts by weight of the C.I. Pigment Blue 15:4, 1 part by weight of the C.I. Pigment Violet 19, 1 part by weight of C.I. Acid Red 52, 100 parts by weight of the alkali-soluble resin (C-1) obtained from Synthesis Example 1, 20 parts by weight of dipentaerythritol hexaacrylate, and 10 parts by weight of 1-[9-ethyl-6-(2-methylbenzoyl)-9H-carbazol-3-yl]-ethylketo 1-(O-acetyloxime) were mixed with 3,000 parts by weight of ethyl 3-ethoxypropionate using a shaker to obtain a blue photosensitive resin composition (Blue-1).

### Preparation Examples b to j

Preparation Examples b to j were conducted in a manner identical to that of Preparation Example a to prepare blue photosensitive resin compositions using the blue pigment combination (A), the red dye component (B), the alkali-soluble resin (C), the compound having at least one ethylenically unsaturated group (D), the photoinitiator (E), and the solvent (F) as well as the amounts thereof illustrated in Table 2.

### Preparation Example

### Preparation of Red Photosensitive Resin Composition

### <Red-1>

160 parts by weight of C.I. Pigment Red 177, 40 parts by weight of C.I. Pigment Red 166, 20 parts by weight of C.I. Pigment Yellow 150, 100 parts by weight of the alkali-soluble resin (C-1) obtained from Synthesis Example 1, 100 parts by weight of dipentaerythritol hexaacrylate, 8 parts by weight of 1-[9-ethyl-6-(2-methylbenzoyl)-9H-carbazol-3-yl]-ethylketo 1-(O-acetyloxime), 10 parts by weight of 2,2′-bis(2,4-dichlorophenyl)-4,4′,5,5′-tetraphenylbiimidazole, and 2,100 parts by weight of ethyl 3-ethoxypropionate were mixed using a shaker to obtain a red photosensitive resin composition (Red-1).

### <Red-2>

Preparation of the red photosensitive resin composition (Red-2) was conducted in a manner identical to preparation of the red photosensitive resin composition (Red-1) except that 180 parts by weight of C.I. Pigment Red 254 and 20 parts by weight of C.I. Pigment Yellow 177 were used.

### Preparation Example

### Preparation of Green Photosensitive Resin Composition

### <Green-1>

100 parts by weight of the alkali-soluble resin (C-1) obtained from Synthesis Example 1, 20 parts by weight of dipentaerythritol hexaacrylate, 10 parts by weight of 1-[9-ethyl-6-(2-methylbenzoyl)-9H-carbazol-3-yl]-ethylketo 1-(O-acetyloxime), 120 parts by weight of the C.I. Pigment Green 07, and 80 parts by weight of the C.I. Pigment Yellow 138 were mixed with 3,000 parts by weight of ethyl 3-ethoxypropionate using a shaker to obtain a green photosensitive resin composition (Green-1).

### <Green-2>

100 parts by weight of the alkali-soluble resin (C-1) obtained from Synthesis Example 1, 50 parts by weight of dipentaerythritol hexaacrylate, 30 parts by weight of 1-[9-ethyl-6-(2-methylbenzoyl)-9H-carbazol-3-yl]-ethylketo 1-(O-acetyloxime), 117 parts by weight of the C.I. Pigment Green 36, and 67 parts by weight of the C.I. Pigment Yellow 139 were mixed with 2,000 parts by weight of ethyl 3-ethoxypropionate using a shaker to obtain a green photosensitive resin composition (Green-2).

### Preparation Example

### Preparation of Color Filter

### Preparation Example 12-a

The blue photosensitive resin composition obtained from Preparation Example a with the aforesaid red photosensitive resin composition (Red-1) and the green photosensitive resin composition (Green-1) were subsequently formed on a glass substrate according to the following steps.

The red photosensitive resin composition (Red-1) was spin-coated on the glass substrate, dried under a reduced pressure of 100 mm Hg for 30 seconds, and pre-baked at a temperature of 80° C. for 3 minutes to form a pre-baked film having a thickness of about 2.5 μm. The pre-baked film was exposed using a mask aligner (Canon PLA-501F, 300 mJ/cm²), was immersed into a developer solution at a temperature of 23° C. for 2 minutes, washed with water, and post-baked at a temperature of 200° C. for 80 minutes to form a red filter segment. The aforesaid procedure was repeated using the green photosensitive resin composition and the blue photosensitive resin composition to form a green filter segment and a blue filter segment. A color filter (12-a) having a thickness of about 2.0 μm was obtained thereby.

### Preparation Examples 12-b to 12-k

Preparation examples 12-b to 12-k were conducted in a manner identical to preparation example 12-a to prepare color filters except that the green photosensitive resin compositions, the red photosensitive resin compositions, and the blue photosensitive resin compositions illustrated in Table 3 were used.

### Preparation Example

### Preparation of Backlight Unit

### Preparation Example 20-1-1

### White Light Emitting Diode

A blue light-emitting die of InGaN (manufactured by Chi Mei Lighting Technology Corp., light-emitting wavelength of 460 nm) was mounted on a lead frame and was electrically connected to the lead frame using wires 25. Photoluminescent phosphor in an encapsulant was formed by mixing yellow phosphor of (SrBa)₂SiO₄:Eu with red phosphor of CaAlSiBN₃:Eu. 18 parts by weight of the yellow phosphor and 2.5 parts by weight of the red phosphor were used based on 100 parts by weight of polysiloxane resin to obtain a white light emitting diode 20-1-1.

### Preparation Examples 20-1-2 to 20-1-5

Preparation examples 20-1-2 to 20-1-5 were conducted in a manner identical to that of preparation example 20-1-1 to prepare white light emitting diodes except that the types and amounts of the yellow phosphor and the red phosphor illustrated in Table 4 were used.

### Preparation Examples 20-2-1

### Trichrome Fluorescent Lamp

Red phosphor of Y₂O₃: Eu, green phosphor of LaPO₄:Ce, Tb, and blue phosphor of (SrCaBa)₅(PO₄)₃Cl:Eu were blended together to form a phosphor blend, which was mixed with a butyl acetate solution of nitrocellulose to obtain a suspension. The suspension was applied to an inner surface of a glass tube having an inner diameter of 32 mm and was dried to form a coating layer on the inner surface of the glass tube. The coating layer was baked at a temperature of 500° C. to form a trichrome fluorescent lamp (20-2-1) of 40 W.

### Preparation Examples 20-2-2 to 20-2-5

Preparation examples 20-2-2 to 20-2-5 were conducted in a manner identical to that of preparation example 20-2-1 to prepare the trichrome fluorescent lamps except that the types and amounts of the blue phosphor, the green phosphor, and the red phosphor illustrated in Table 4 were used.

### Example

### Color Liquid Crystal Display Device

### Example 1

The color filter obtained in preparation example 12-a was formed on a first substrate 11, a conducting layer 15 composed of ITO was then formed on the color filter, and an alignment layer 16 composed of polyimide was then formed on the conducting layer 15.

A thin-film transistor 14 was formed on a second substrate 13, a conducting layer 15 composed of ITO was formed on the thin-film transistor 14, and an alignment layer 16 composed of polyimide was formed on the conducting layer 15.

Spacers were applied onto the alignment layers 16. The first substrate 11 and the second substrate 13 were combined together by sealing with a sealant in a manner of leaving a hole for liquid crystal injection. Liquid crystal was inj ected via the liquid crystal inj ection hole, followed by sealing the liquid crystal injection hole. Polarizers were attached to the two substrates. A liquid crystal display element was then obtained.

A liquid crystal display device can be produced by combining the aforesaid liquid crystal display element with the backlight unit 20-1-2.

### Examples 2 to 7 and Comparative Examples 1 to 8

Examples 2 to 7 and comparative examples 1 to 8 were conducted in a manner identical to example 1 to prepare the color liquid crystal display devices except that the types of the color filter and the backlight unit illustrated in Table 5 were used.

### [Measurements]

### 1. Color Temperature of Backlight Unit:

CIE chromaticity coordinate values (x, y) of the backlight units were determined using a colorimeter (manufactured by Otsuka Electronics Co., Model No. MCPD). Relative color temperatures of backlight units 20-1-1 to 20-1-5 and 20-2-1 to 20-2-5 were determined using chromaticity coordinate values (x, y) and isotemperature line.

### 2. Color Reproduction:

CIE chromaticity coordinate value of a color liquid crystal display device was determined using the colorimeter. NTSC ratio can be obtained by dividing color gamut of measured CIE chromaticity coordinates by color gamut of standard CIE chromaticity coordinates. A higher NTSC ratio means better color reproduction.

⊚: NTSC ratio>90%;
◯: 85%<NTSC ratio≦90%;
Δ: 80%<NTSC ratio≦85%;
X: NTSC ratio≦80%.

TABLE 1

| | | | | | | | | | | Copolymerization Condition | | |
|---|---|---|---|---|---|---|---|---|---|---|---|---|
| | Composition (parts by weight) | | | | | | | | | | Reac. | Reac. |
| Syn. | Monomers for Copolymerization | | | | | | | Initiator | Solvent | Feeding | Temp. | Time |
| Ex. # | HOMS | MAA | SM | DCPOA | BzMA | PMI | MA | AMBN | EEP | manner | (° C.) | (hrs) |
| 1 | 45 | — | 40 | 15 | — | — | — | 4 | 200 | Continuous | 100 | 6 |
| 2 | — | 35 | — | — | 45 | 5 | 15 | 4 | 200 | Continuous | 100 | 6 |
| 3 | 25 | 20 | 15 | — | 20 | — | 20 | 4 | 200 | Continuous | 100 | 6 |

Note:
HOMS: 2-methacryloylethoxy succinate
MAA: methacrylic acid
SM: styrene monomer
DCPOA: dicyclopentenyloxyethyl acrylate
BzMA: benzyl methacrylate
PMI: N-phenylmaleimide
MA: methyl acrylate
AMBN: 2,2′-azobis-2-methyl butyronitrile
EEP: ethyl 3-ethoxypropionate

TABLE 2

| Components | | | Preparation Examples | | | | | | | | | |
|---|---|---|---|---|---|---|---|---|---|---|---|---|
| Unit: parts by weight | | | a | b | c | d | e | f | g | h | i | j |
| blue | A-1 | C.I. PB 15:4 | 90 | 70 | — | 10 | — | — | 90 | — | — | — |
| pigment | | C.I. PB 15:5 | — | — | 50 | 10 | 3 | 1 | — | — | 50 | — |
| component | | C.I. PB60 | — | 5 | — | — | — | — | — | — | — | 50 |
| (A) | A-2 | C.I. PV19 | 1 | — | — | — | — | — | — | — | — | — |
| | | C.I. PV23 | — | 1 | — | — | — | — | — | — | — | — |
| red dye | B-1 | Formula (1) | 1 | — | — | — | 10 | — | — | — | — | 20 |
| component | B-2 | Formula (22) | — | 10 | — | — | 5 | — | 0.5 | — | — | — |
| (B) | B-3 | Formula (28) | — | — | 30 | — | — | 10 | — | 40 | — | 10 |
| | B-4 | Formula (31) | — | — | — | 50 | — | 20 | — | — | — | — |

| Weight ratio (A)/(B) | | 91.00 | 7.60 | 1.67 | 0.40 | 0.20 | 0.03 | 180.0 | 0 | — | 1.67 |
|---|---|---|---|---|---|---|---|---|---|---|---|
| Alkali-soluble | C-1 | 100 | — | — | 100 | — | — | 50 | 100 | 100 | — |
| resin (C) | C-2 | — | 100 | 50 | — | — | — | 50 | — | — | — |
| | C-3 | — | — | 50 | — | 100 | 100 | — | — | — | 100 |
| A compound | D-1 | 20 | 50 | 30 | 50 | 100 | — | 50 | 50 | 50 | 40 |
| having at least | D-2 | — | — | — | — | — | 20 | 50 | — | — | 60 |
| one ethylenically | | | | | | | | | | | |
| unsaturated | | | | | | | | | | | |
| group (D) | | | | | | | | | | | |
| Photoinitiator | E-1 | 10 | 30 | 10 | 30 | — | — | 10 | 30 | 30 | — |
| (E) | E-2 | — | — | 5 | — | 25 | 5 | 5 | — | — | 10 |
| | E-3 | — | — | 10 | — | 25 | 10 | 10 | — | — | — |
| Solvent (F) | F-1 | 3000 | 2000 | — | 1000 | 1000 | 500 | 500 | 1000 | 1000 | — |
| | F-2 | — | — | 500 | — | — | 500 | 500 | — | — | 1000 |

Note:
D-1: dipentaerythritol hexaacrylate (manufactured by Toagosei);
D-2: trimethylolpropyl triacrylate;
E-1: 1-[9-ethyl-6-(2-methylbenzoyl)-9H-carbazol-3-yl]-ethylketo 1-(O-acetyloxime);
E-2: 2,2′-bis(2,4-dichlorophenyl)-4,4′,5,5′-tetraphenylbiimidazole;
E-3: 2,4-bis(trichloromethyl)-6-(p-methoxy)styryl-s-triazine;
F-1: ethyl 3-ethoxypropionate;
F-2: propylene glycol methyl ether acetate.

TABLE 3

| | | Green | Red | Green |
|---|---|---|---|---|
| | | Photosensitive | Photosensitive | Photosensitive |
| | | Resin | Resin | Resin |
| Components | | Composition | Composition | Composition |
| Color | 12-a | Prep. Ex. a | Red-1 | Green-1 |
| Filter | 12-b | Prep. Ex. b | | |
| Prep. | 12-c | Prep. Ex. c | | |
| Ex. | 12-d | Prep. Ex. d | | |
| | 12-e | Prep. Ex. e | | |
| | 12-f | Prep. Ex. f | | |
| | 12-g | Prep. Ex. g | | |
| | 12-h | Prep. Ex. h | | |
| | 12-i | Prep. Ex. i | | |
| | 12-j | Prep. Ex. j | | |
| | 12-k | Prep. Ex. c | Red-2 | Green-2 |

TABLE 4

| | | Backlight Unit | | | | | | | | | |
|---|---|---|---|---|---|---|---|---|---|---|---|
| | | White Light Emitting Diode 20-1 | | | | | Trichrome Fluorescent Lamp 20-2 | | | | |
| Prep. Ex. | | 20-1-1 | 20-1-2 | 20-1-3 | 20-1-4 | 20-1-5 | 20-2-1 | 20-2-2 | 20-2-3 | 20-2-4 | 20-2-5 |
| Yellow | Composition | (SrBa)₂Si | (SrBa)₂Si | Y₃(Al,Ga)₅ | Y₃(Al,Ga)₅ | Y₃(Al,Ga)₅ | — | — | — | — | — |
| | | O₄: Eu | O₄: Eu | O₁₂: Ce | O₁₂: Ce | O₁₂: Ce | | | | | |
| | Amount | 18 | 16 | 14.5 | 13.2 | 11 | — | — | — | — | — |
| Red | Composition | CaAlSiBN₃: Eu | CaAlSiBN₃: Eu | CaAlSiBN₃: Eu | Y₂O₃: Eu | Y₂O₃: Eu | Y₂O₃: Eu | | | | |
| | Amount | 2.5 | 2 | 1.5 | 0.9 | 0.5 | 40 | 35 | 33 | 31 | 30 |
| Green | Composition | — | — | — | — | — | LaPO₄: Ce, Tb | | | | |
| | Amount | — | — | — | — | — | 35 | 34 | 33 | 32 | 30 |
| Blue | Composition | — | — | — | — | — | (SrCaBa)₅(PO₄)₃Cl: Eu | | | | |
| | Amount | — | — | — | — | — | 25 | 31 | 34 | 38 | 40 |

| | | | | | | | | | | |
|---|---|---|---|---|---|---|---|---|---|---|
| Color Temp. (K) | 3,934 | 8,090 | 13,532 | 19,805 | 22,260 | 3,512 | 8,125 | 13,845 | 19,780 | 22,122 |

Wavelength of (SrBa)₂SiO₄: Eu: 550 to 570 nm; Wavelength of Y₃(Al,Ga)₅O₁₂: Ce: 520 to 550 nm;
Wavelength of CaAlSiBN₃: Eu: 650 to 670 nm; Wavelength of Y₂O₃: Eu: 610 to 630 nm.

TABLE 5

| Liquid | | | | | | Evaluation |
|---|---|---|---|---|---|---|
| Crystal | | | | | Color | Items |
| Display | | Color | | Backlight | Temperature | Color |
| Device | | Filter | (A)/(B) | unit | (K) | reproduction |
| Example | 1 | 12-a | 91.00 | 20-1-2 | 8,090 | ⊚ |
| | 2 | 12-b | 7.60 | 20-1-3 | 13,532 | ⊚ |
| | 3 | 12-c | 1.67 | 20-1-4 | 19,805 | ◯ |
| | 4 | 12-d | 0.40 | 20-1-2 | 8,090 | ◯ |
| | 5 | 12-e | 0.20 | 20-2-2 | 8,125 | ◯ |
| | 6 | 12-f | 0.03 | 20-2-3 | 13,845 | Δ |
| | 7 | 12-g | 180.0 | 20-2-4 | 19,780 | Δ |
| Comp. | 1 | 12-a | 91.00 | 20-1-1 | 3,934 | X |
| Example | 2 | 12-b | 7.60 | 20-1-5 | 22,260 | X |
| | 3 | 12-c | 1.67 | 20-2-1 | 3,512 | X |
| | 4 | 12-d | 0.40 | 20-2-5 | 22,122 | X |
| | 5 | 12-h | 0 | 20-1-2 | 8,090 | X |
| | 6 | 12-i | — | 20-2-2 | 8,125 | X |
| | 7 | 12-j | 1.67 | 20-2-2 | 8,125 | X |
| | 8 | 12-k | 1.67 | Illuminant | 22,122 | X |
| | | | | C | | |

As shown in Table 5, a color liquid crystal display device having better color reproduction can be obtained when the blue photosensitive resin compositions in Examples 1 to 7 are composed of the copper phthalocyanine-based blue pigment (A-1) and the red dye component (B) and the color temperature of the backlight unit is controlled to be within a range from 8,090 K to 19,805 K.

As for comparative examples 1 to 4, although the blue photosensitive resin compositions are composed of the copper phthalocyanine-based blue pigment (A-1) and the red dye component (B), the color temperature of the backlight unit is either lower than 8,000K or higher than 20,000K. The color liquid crystal display devices do not have better color reproduction.

As for comparative example 5, although the color temperature of the backlight unit is controlled to be within a range from 8,000 K to 20,000 K, the copper phthalocyanine-based blue pigment (A-1) was not used to form the blue photosensitive resin composition. The color liquid crystal display device does not have better color reproduction.

As for comparative example 6, although the color temperature of the backlight unit is controlled to be within a range from 8,000 K to 20,000 K, the red dye component (B) was not used to form the blue photosensitive resin composition. The color liquid crystal display device does not have better color reproduction.

As for comparative example 7, although the color temperature of the backlight unit is controlled to be within a range from 8,000 K to 20,000 K, the copper phthalocyanine-based blue pigment (A-1) was not used to form the blue photosensitive resin composition. The color liquid crystal display device does not have better color reproduction.

As for comparative examples 8, although the blue photosensitive resin composition is composed of the copper phthalocyanine-based blue pigment (A-1) and the red dye component (B), illuminant C was a cold cathode ray tube used as the backlight source. The color liquid crystal display device does not have better color reproduction.

In this invention, a color liquid crystal display device having better color reproduction can be obtained by using a blue photosensitive resin composition which includes the copper phthalocyanine-based blue pigment (A-1) and the red dye component (B) together with the backlight unit having a color temperature ranging from 8,000 K to 20,000 K.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A color liquid crystal display device, comprising:
a liquid crystal display element including a color filter having a blue filter segment, a green filter segment, and a red filter segment, said blue filter segment being prepared from a blue photosensitive resin composition which includes a blue pigment component, a red dye component, an alkali-soluble resin, a compound having at least one ethylenically unsaturated group, a photoinitiator, and a solvent for dispersing said blue pigment component, said red dye component, said alkali-soluble resin, said compound having at least one ethylenically unsaturated group, and said photoinitiator, said blue pigment component including a copper phthalocyanine-based blue pigment; and
a backlight unit coupled to said liquid crystal display element and having a color temperature ranging from 8,000 K to 20,000 K.

2. The color liquid crystal display device as claimed in claim 1, wherein said red dye component includes a red dye represented by formula (I): 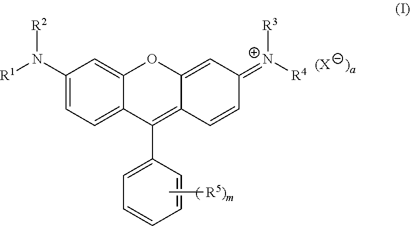
wherein
R¹, R², R³, and R⁴ are independently selected from the group consisting of hydrogen, —R⁶, and a C₆-C₁₀ aryl group unsubstituted or substituted with a substituent selected from the group consisting of halogen, —R⁶, —OH, —OR⁶, —SO₃⁻, —SO₃H, —SO₃M, —COOH, —COOR⁶, —SO₃R⁶, —SO₂NHR⁸, and —SO₂NR⁸R⁹;
R⁵ is selected from the group consisting of —SO₃⁻, —SO₃H, —SO₃M, —COOH, —COOR⁶, —SO₃R⁶, —SO₂NHR⁸, and —SO₂NR⁸R⁹;
m is an integer ranging from 0 to 5, a plurality of R⁵s being the same or different when m is from 2 to 5;
X represents halogen;
a is 0 or 1;
R⁶ is a C₁-C₁₀ alkyl group unsubstituted or substituted with halogen, —CH₂— contained in said C₁-C₁₀ alkyl group being optionally replaced with —O—, carbonyl, or —NR⁶—;
R⁸ and R⁹ are independently selected from the group consisting of a C₁-C₁₀ straight chain alkyl group, a C₁-C₁₀ branched chain alkyl group, a C₃-C₃₀ cycloalkyl group, and -Q, and optionally join together to form a C₁-C₁₀ heterocyclic group unsubstituted or substituted with a substituent selected from the group consisting of R⁶, —OH, and -Q, said C₁-C₁₀ straight chain alkyl group, said C₁-C₁₀ branched chain alkyl group, and said C₃-C₃₀ cycloalkyl group being unsubstituted or substituted with a substituent selected from the group consisting of hydroxyl, halogen, -Q, —CH ═CH₂, and —CH═CH—R⁶, —CH₂— contained in said C₁-C₁₀ straight chain alkyl group, said C₁-C₁₀ branched chain alkyl group, and said C₃-C₃₀ cycloalkyl group being optionally replaced with —O—, carbonyl, or —NR⁶—;
Q is selected from the group consisting of a C₆-C₁₀ aryl group and a C₅-C₁₀ heteroaryl group, which are independently unsubstituted or substituted with a substituent selected from the group consisting of halogen, —R⁶, —OH, —OR⁶, —NO₂, —CH═CH₂, and —CH═CH—R⁶; and
M is selected from the group consisting of potassium and sodium.

3. The color liquid crystal display device as claimed in claim 1, wherein said red dye component includes a red dye represented by formula (I-1): 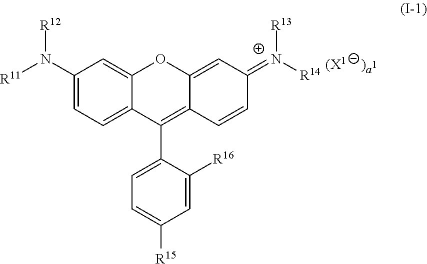
wherein
R¹¹, R¹², R¹³, and R¹⁴ are independently selected from the group consisting of hydrogen, —R⁶, and a C₆-C₁₀ aryl group, said C₆-C₁₀ aryl group being unsubstituted or substituted with a substituent selected from the group consisting of halogen, —R⁶, —OH, —OR⁶, —SO₃⁻, —SO₃H, —SO₃Na, —COOH, —COOR⁶, —SO₃R⁶, —SO₂NHR⁸, and —SO₂NR⁸R⁹;
R¹⁵ is selected from the group consisting of hydrogen, —SO₃⁻, —SO₃H, —SO₂NHR⁸, and —SO₂NR⁸R⁹;
R¹⁶ is selected from the group consisting of —SO₃⁻, —SO₃H, —SO₂NHR⁸, and —SO₂NR⁸R⁹;
X¹ is halogen;
a¹ is 0 or 1;
R⁶ is a C₁-C₁₀ alkyl group unsubstituted or substituted with halogen, —CH2- contained in said C₁-C₁₀ alkyl group being optionally replaced with —O—, carbonyl, or —NR⁶—;
R⁸ and R⁹ are independently selected from the group consisting of a C₁-C₁₀ straight chain alkyl group, a C₁-C₁₀ branched chain alkyl group, a C₃-C₃₀ cycloalkyl group, and -Q, and optionally join together to form a C₁-C₁₀ heterocyclic group unsubstituted or substituted with a substituent selected from the group consisting of R⁶, —OH, and -Q, said C₁-C₁₀ straight chain alkyl group, said C₁-C₁₀ branched chain alkyl group, and said C₃-C₃₀ cycloalkyl group being unsubstituted or substituted with a substituent selected from the group consisting of hydroxyl, halogen, -Q, —CH═CH₂, and —CH═CH—R⁶, —CH₂— contained in said C₁-C₁₀ straight chain alkyl group, said C₁-C₁₀ branched chain alkyl group, and said C₃-C₃₀ cycloalkyl group being optionally replaced with —O—, hydroxyl, or —NR⁶—; and
Q is selected from the group consisting, of a C₆-C₁₀ aryl group and a C₅-C₁₀ heteroaryl group, which are independently unsubstituted or substituted with a substituent selected from the group consisting of halogen, —R⁶, —OH, —OR⁶, —NO₂, —CH═CH₂, and —CH═CH—R⁶.

4. The color liquid crystal display device as claimed in claim 1, wherein said red dye component includes a red dye represented by formula (I-2): 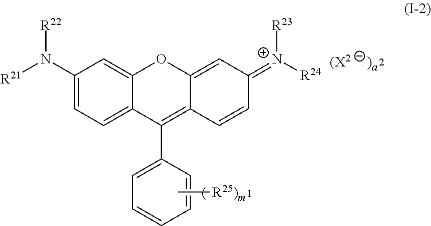
wherein
R²¹, R²², R²³, and R²⁴ are independently selected from the group consisting of hydrogen, —R²⁶, and a C₆-C₁₀ aryl group unsubstituted or substituted with a substituent selected from the group consisting of halogen, —R²⁶, —OH, —OR²⁶, —SO₃H, —SO₃Na, —COOH, —COOR²⁶, —SO₃R²⁶, and —SO₂NHR²⁸;
R²⁵ is selected from the group consisting of —SO₃⁻, —SO₃Na, —COOH, —COOR²⁶, —SO₃H, and —SO₂NHR²⁸;
m¹ is an integer ranging from 0 to 5, a plurality of R²⁵s being the same or different when m¹ is from 2 to 5;
X² represents halogen;
a² is 0 or 1;
R²⁶ is a C₁-C₁₀ alkyl group unsubstituted or substituted with a substituent selected from the group consisting of halogen and —OR²⁶; and
R²⁸ is selected from the group consisting of hydrogen, —R²⁶, —COOR²⁶, and a C₆-C₁₀ aryl group unsubstituted or substituted with a substituent selected from the group consisting of —R²⁶ and —OR²⁶.

5. The color liquid crystal display device as claimed in claim 1, wherein said red dye component includes a red dye represented by formula (I-3): 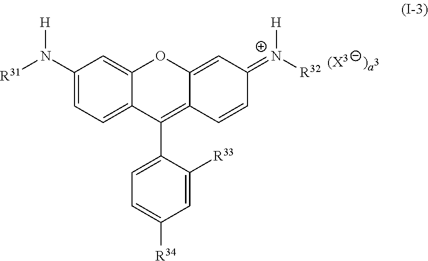
wherein
R³¹ and R³² are independently phenyl unsubstituted or substituted with a substituent selected from the group consisting of halogen, —R²⁶, —OR²⁶, —COOR²⁶, —SO₃R²⁶, and —SO₂NHR²⁸;
R³³ is selected from the group consisting of —SO₃⁻ and —SO₂NHR²⁸;
R³⁴ is selected from the group consisting of hydrogen, —SO₃⁻, and —SO₂NHR²⁸;
X³ is halogen;
a³ is 0 or 1;
R²⁶ is a C₁-C₁₀ alkyl group unsubstituted or substituted with a substituent selected from the group consisting of halogen and —OR²⁶; and
R²⁸ is selected from the group consisting of hydrogen, —R²⁶, —COOR²⁶, and a C₆-C₁₀ aryl group unsubstituted or substituted with a substituent selected from the group consisting of —R²⁶ and —OR²⁶.

6. The color liquid crystal display device as claimed in claim 1, wherein said red dye component includes a red dye represented by formula (I-4): 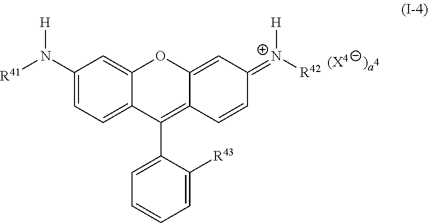
wherein
R⁴¹ and R⁴² are independently phenyl unsubstituted or substituted with a substituent selected from the group consisting of —R²⁶ and —SO₂NHR²⁸;
R⁴³ is selected from the group consisting of —SO₃⁻ and —SO₂NHR²⁸;
X⁴ is halogen;
a⁴ is 0 or 1;
R²⁶ is C₁-C₁₀ alkyl group unsubstituted or substituted with a substituent selected from the group consisting of halogen and —OR²⁶; and
R²⁸ is selected from the group consisting of hydrogen, —R²⁶, —COOR²⁶, and a C₆-C₁₀ aryl group unsubstituted or substituted with a substituent selected from the group consisting of —R²⁶ and —OR²⁶.

7. The color liquid crystal display device as claimed in claim 1, wherein said blue pigment component is used in an amount ranging from 1 part by weight to 100 parts by weight, said red dye component is used in an amount ranging from 0.5 part by weight to 50 parts by weight, said compound having an ethylenically unsaturated group is used in an amount ranging from 10 parts by weight to 500 parts by weight, said photoinitiator is used in an amount ranging from 1 part by weight to 200 parts by weight, and said solvent is used in an amount ranging from 50 parts by weight to 5,000 parts by weight based on 100 parts by weight of said alkali-soluble resin.

8. The color liquid crystal display device as claimed in claim 1, wherein said copper phthalocyanine-based blue pigment is used in an amount ranging from 1 part by weight to 90 parts by weight based on 100 parts by weight of said alkali-soluble resin.

9. The color liquid crystal display device as claimed in claim 1, wherein a weight ratio of said blue pigment component to said red dye component ranges from 0.1 to 100.

10. The color liquid crystal display device as claimed in claim 1, wherein said blue pigment component further includes a purple pigment.

11. The color liquid crystal display device as claimed in claim 1, wherein said backlight unit is selected from a group consisting of a white light emitting diode, a trichrome fluorescent lamp, and a combination thereof.

12. The color liquid crystal display device as claimed in claim 11, wherein said backlight unit is said white light emitting diode including a light emitting layer having a main peak of luminescent spectrum ranging from 430 nm to 500 nm, and a photoluminescent phosphor, said light emitting layer being made of a material selected from a group consisting of a nitride compound semiconductor, a group III-V compound semiconductor, a group II-IV compound semiconductor, a group IV-VI compound semiconductor, and combinations thereof.

13. The color liquid crystal display device as claimed in claim 12, wherein said photoluminescent phosphor is selected from the group consisting of a yellow phosphor, a green phosphor, a red phosphor, and combinations thereof.

14. The color liquid crystal display device as claimed in claim 13, wherein said yellow phosphor is selected from the group consisting of a cerium activated aluminum garnet phosphor, a europium activated alkaline earth metal silicate phosphor, and a combination thereof, said cerium activated aluminum garnet phosphor being selected from the group consisting of a phosphor of RE₃(Al, Ga)₅O₁₂:Ce, a phosphor of (Tb, Al)₅O₁₂:Ce, and a combination thereof, wherein RE is selected from the group consisting of Y, Gd, La, and combinations thereof, said europium activated alkaline earth metal silicate phosphor being selected from the group consisting of a phosphor of AE₂SiO₄:Eu, a phosphor of Sr₃SiO₅:Eu²⁺, and a combination thereof, wherein AE is selected from the group consisting of Sr, Ba, Ca, and combinations thereof.

15. The color liquid crystal display device as claimed in claim 13, wherein said green phosphor is selected from the group consisting of a cerium activated phosphor, a europium activated alkaline earth metal silicate phosphor, and a combination thereof, said cerium activated phosphor being selected from the group consisting of a phosphor of RE₃(Al, Ga)₅O₁₂:Ce, a phosphor of Ca₃Sc₂O₄:Ce, and a combination thereof, wherein RE is selected from the group consisting of Y, Gd, La, and combinations thereof, said europium activated alkaline earth metal silicate phosphor being selected from the group consisting of a phosphor of AE₂SiO₄:Eu, a phosphor of Ca₃Sc₂Si₃O₁₂:Eu, and a combination thereof, wherein AE is selected from the group consisting of Sr, Ba, Ca, and combinations thereof.

16. The color liquid crystal display device as claimed in claim 13, wherein said red phosphor is selected from the group consisting of a europium activated oxide phosphor, a europium activated sulfide phosphor, a europium activated nitride phosphor, and combinations thereof.

17. The color liquid crystal display device as claimed in claim 16, wherein said europium activated oxide phosphor is Y₂O₃: Eu, said europium activated sulfide phosphor being selected from the group consisting of Y₂O₂S:Eu, La₂O₂S:Eu, and combinations thereof, said europium activated nitride phosphor being selected from the group consisting of AE₂Si₅N₈:Eu²⁺, CaAlSiN₃:Eu²⁺, CaAlSiBN₃:Eu, and combinations thereof, wherein AE is selected from a group consisting of Sr, Ba, Ca, and combinations thereof.

18. The color liquid crystal display device as claimed in claim 11, wherein said backlight unit is said trichrome fluorescent lamp which includes a blue phosphor, a green phosphor, and a red phosphor that cooperate to form a phosphor combination.

19. The color liquid crystal display device as claimed in claim 18, wherein said blue phosphor is selected from the group consisting of Sr₅(PO₄)₃Cl:Eu; (SrCaBa)₅(PO₄)₃Cl:Eu, BaMg₂Al₁₆O₂₇:Eu, and combinations thereof, said green phosphor is selected from the group consisting of LaPO₄:Ce,Tb, (CeTb)MgAl₁₄O₁₉, and a combination thereof, and said red phosphor is Y₂O₃:Eu.

20. The color liquid crystal display device as claimed in claim 18, wherein said blue phosphor is in an amount ranging from 20 to 55 wt %, said green phosphor is in an amount ranging from 20 to 55 wt %, and said red phosphor is in an amount ranging from 20 to 45 wt % based on 100 wt % of said phosphor combination.
